(19) United States
(12) Patent Application Publication
(10) Pub. No.: US 2025/0304368 A1
(43) Pub. Date: Oct. 2, 2025

(54) MODULAR SHELF STRUCTURE AND STORAGE AND RETRIEVAL SYSTEM INCLUDING SAME

(71) Applicant: Symbotic LLC, Wilmington, MA (US)

(72) Inventors: Velibor Kilibarda, Wilmington, MA (US); Brendan Blennerhassett, Wilmington, MA (US); Cristian Faria, Wilmington, MA (US); Richard B. Cohen, Keene, NH (US)

(21) Appl. No.: 19/097,068

(22) Filed: Apr. 1, 2025

Related U.S. Application Data
(60) Provisional application No. 63/573,246, filed on Apr. 2, 2024.

(51) Int. Cl. B65G 1/04; B61C 13/04

(52) U.S. Cl. CPC B65G 1/0492; B61C 13/04; B65G 2207/30

(57) ABSTRACT

A bot-shelf structure for an automatic store and retrieval system having store racks and self-navigating automatic robots, the bot-shelf structure includes an array of the store racks, a first type of structure module that defines a module part of the array, the assembly having more than one of the first type of structure module, each of which is interchangeable with each other, and has an integral structural datum feature determining a predetermined bot traverse reference level of each level of the array. A second type of structure module connected to the first type of structure module, where the second type of structure module has control features having a predetermined relationship with the integral structural datum feature of the first type of structure module, the control features being configured so that each second type of structure module is interchangeable with each other second type of structure module.

### CROSS REFERENCE TO RELATED APPLICATIONS

This application is a non-provisional of and claims the benefit of U.S. Provisional patent application No. 63/573,246, filed Apr. 2, 2024, the disclosure of which is incorporated herein by reference in its entirety.

### BACKGROUND

### 1. Field

The present disclosure generally relates to material handling systems, and more particularly, to storage structures of the material handling systems.

### 2. Brief Description of Related Developments

Material handling systems, such as of logistics facilities includes storage units (e.g., in the form of multilevel racks) that store goods on pallets, in cases, in bins, on trays, etc. These goods are stored to and removed from the storage units with automation such as stacker cranes that travel on a facility floor between storage units, or automated vehicles that travel along riding surfaces of a respective level of the material handling system for accessing storage aisles, of the storage units, at the respective level. Generally, the setup and installation of these storage units, and in particular those employed with the automated vehicles, includes a complex structure including many different components that are typically bolted or welded together with somewhat relaxed dimensional tolerances and requiring post assembly adjustment and alignment. The relaxed dimensional tolerances may induce vibration to automated vehicles travelling on and along the structure of the storage units. The components of the storage units are also assembled and installed in relation to and aligned (e.g., manually by employing special tools and repeated adjustments post assembly) with other components of the material handling system, e.g., autonomous vehicle transfer decks, lifts, etc., which makes the installation labor intensive and time consuming (i.e., increases the time needed to validate the structure for commission the structure into service).

The storage units, whether installed for employment with stacker cranes or autonomous vehicles, are generally constructed with posts that support the goods shelves. These posts divide the storage shelves, on the same storage level, into sections. Here, the space occupied by the posts reduces storage capacity of the storage units.

Further, where the storage units are employed with autonomous vehicles in a multilevel material handling system (i.e., where autonomous transport vehicles are confined to a respective level or travel between different levels of the multilevel material handling system), riding surfaces of the automated vehicles in the storage aisles are generally supported by goods shelves of the storage units. Automated vehicles travelling along the storage aisles may induce vibration to the goods seated on the goods shelves and/or a weight of the goods on the storage shelf may distort the riding surfaces of the automated vehicles.

### BRIEF DESCRIPTION OF THE DRAWINGS

The foregoing aspects and other features of the present disclosure are explained in the following description, taken in connection with the accompanying drawings, wherein:

FIG. 1A is a schematic block diagram of an automatic store and retrieval system incorporating aspects of the present disclosure;

FIG. 1B is an exemplary schematic illustration of the automatic store and retrieval system of FIG. 1 in accordance with aspects of the present disclosure;

FIG. 2A is an exemplary schematic perspective illustration of a portion of the automatic store and retrieval system of FIG. 1 in accordance with aspects of the present disclosure;

FIG. 2B is an exemplary schematic plan illustration of the automatic store and retrieval system of FIG. 1 in accordance with aspects of the present disclosure;

FIG. 2C is an exemplary schematic perspective illustration of a portion of the automatic store and retrieval system of FIG. 1 in accordance with aspects of the present disclosure;

FIG. 2D is an exemplary schematic perspective illustration of modular parts of the automatic store and retrieval system of FIG. 1 in accordance with aspects of the present disclosure;

FIGS. 3A-3C are schematic illustrations of a modular part of the automatic store and retrieval system of FIG. 1 in accordance with aspects of the present disclosure;

FIGS. 4A-4C are schematic illustrations of a modular part of the automatic store and retrieval system of FIG. 1 in accordance with aspects of the present disclosure;

FIG. 5 is a schematic illustration of a modular part of the automatic store and retrieval system of FIG. 1 in accordance with aspects of the present disclosure;

FIGS. 6A-6D are schematic illustrations of a modular part of the automatic store and retrieval system of FIG. 1 in accordance with aspects of the present disclosure;

FIG. 7 is a schematic perspective illustration of a portion of an exemplary shelf assembly of the automatic store and retrieval system of FIG. 1 in accordance with aspects of the present disclosure;

FIG. 8 is a schematic perspective illustration of a portion of the exemplary shelf assembly of the automatic store and retrieval system of FIG. 1 in accordance with aspects of the present disclosure;

FIGS. 9A and 9B are schematic illustrations of portions of the exemplary shelf assembly of the automatic store and retrieval system of FIG. 1 in accordance with aspects of the present disclosure;

FIG. 10 is a schematic perspective illustration of a portion of the exemplary shelf assembly of the automatic store and retrieval system of FIG. 1 in accordance with aspects of the present disclosure;

FIG. 11 is a schematic block diagram of an assembly jig that may be employed with modular parts of the automatic store and retrieval system of FIG. 1 in accordance with aspects of the present disclosure;

FIGS. 12A-12D are schematic illustrations of a modular part of the automatic store and retrieval system of FIG. 1 in accordance with aspects of the present disclosure; and

FIGS. 13 and 14 are schematic block diagrams of exemplary methods in accordance with aspects of the present disclosure.

### DETAILED DESCRIPTION

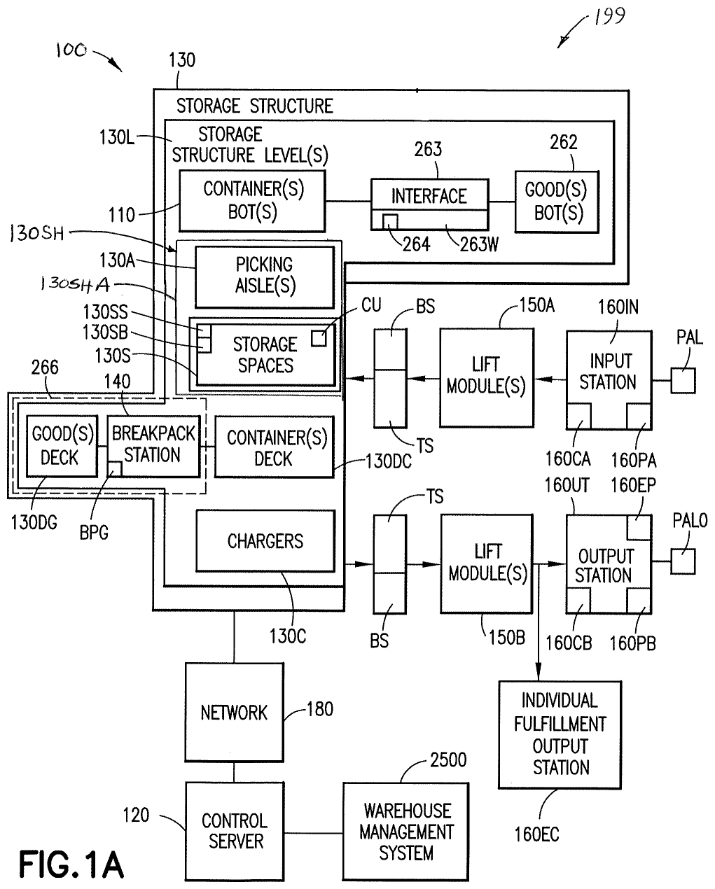

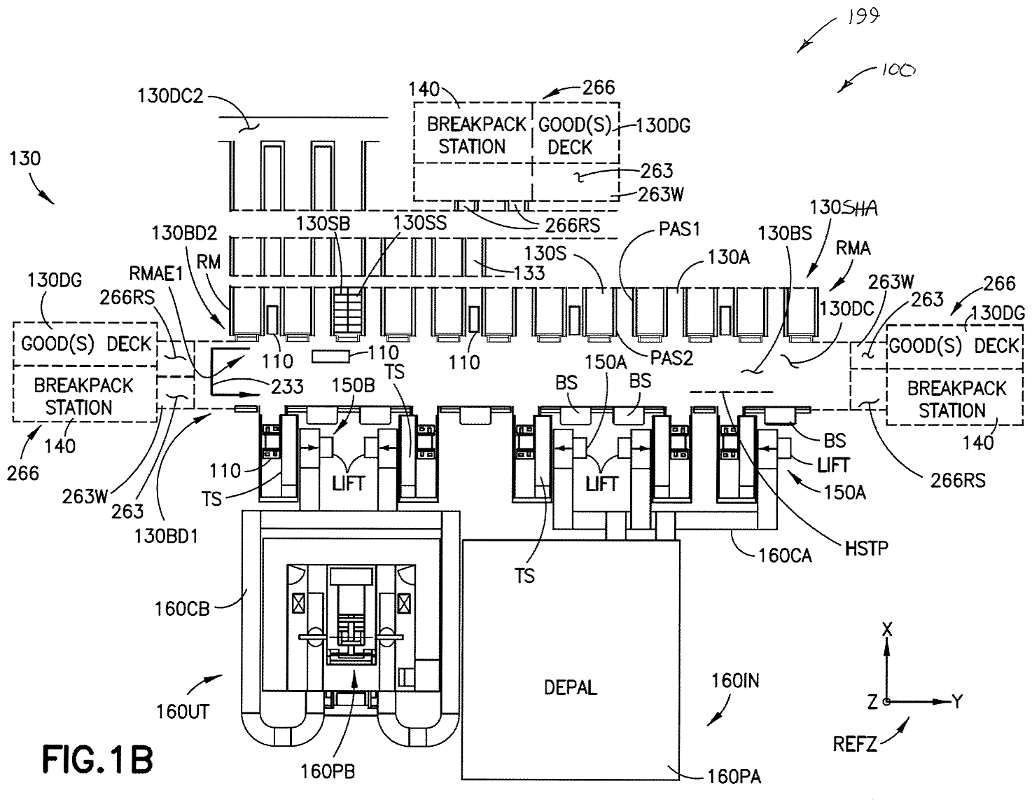

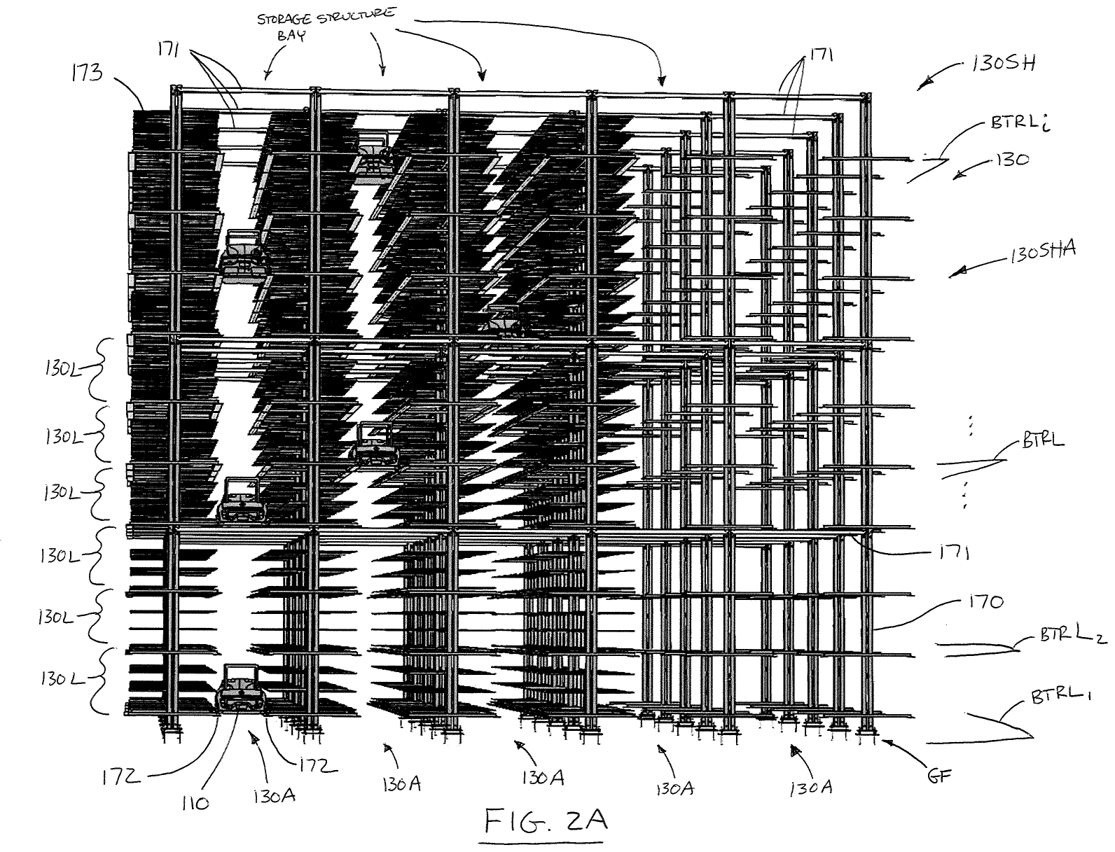

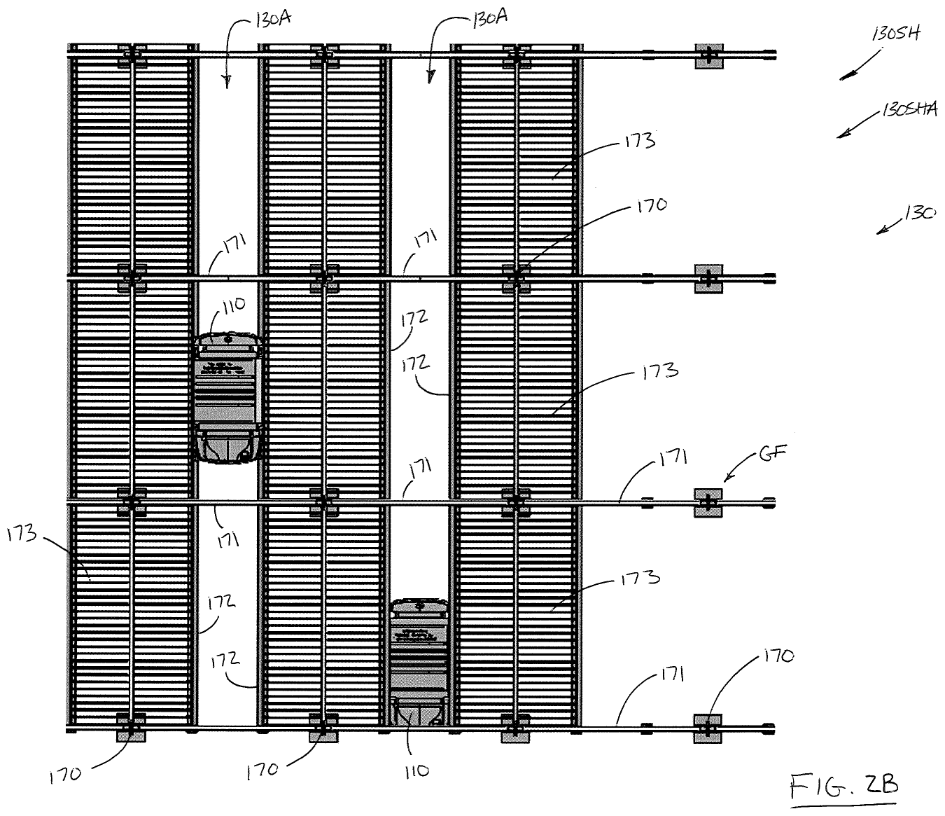

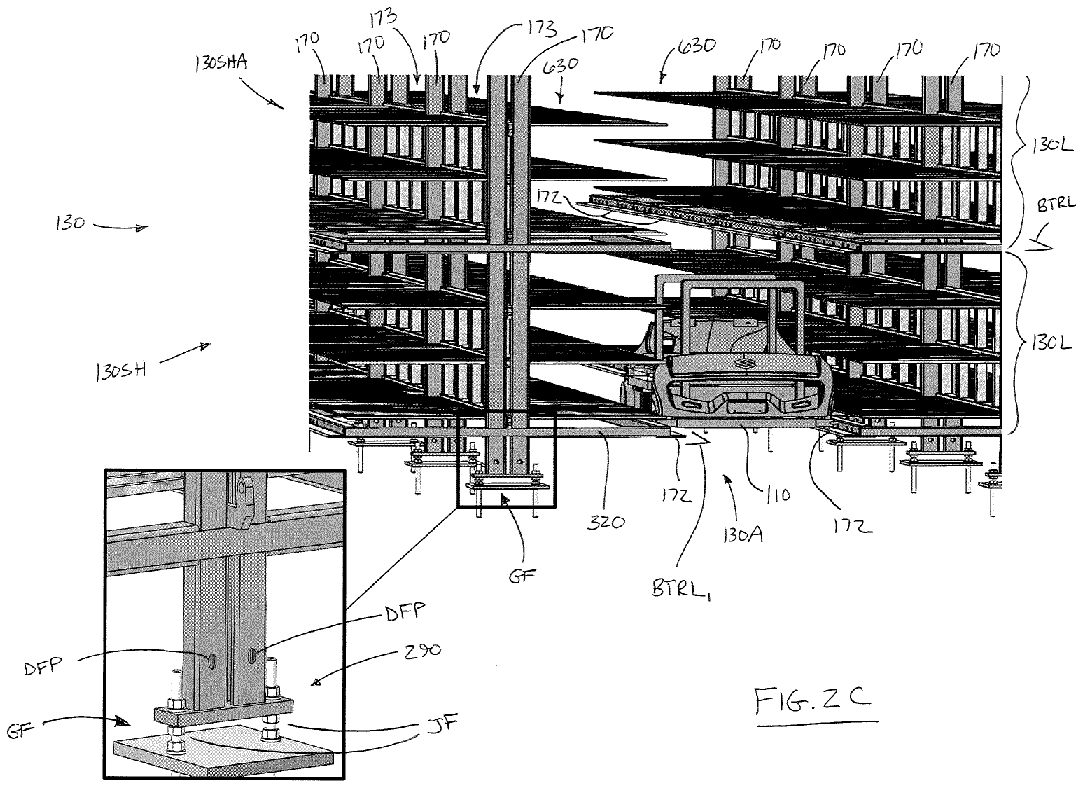

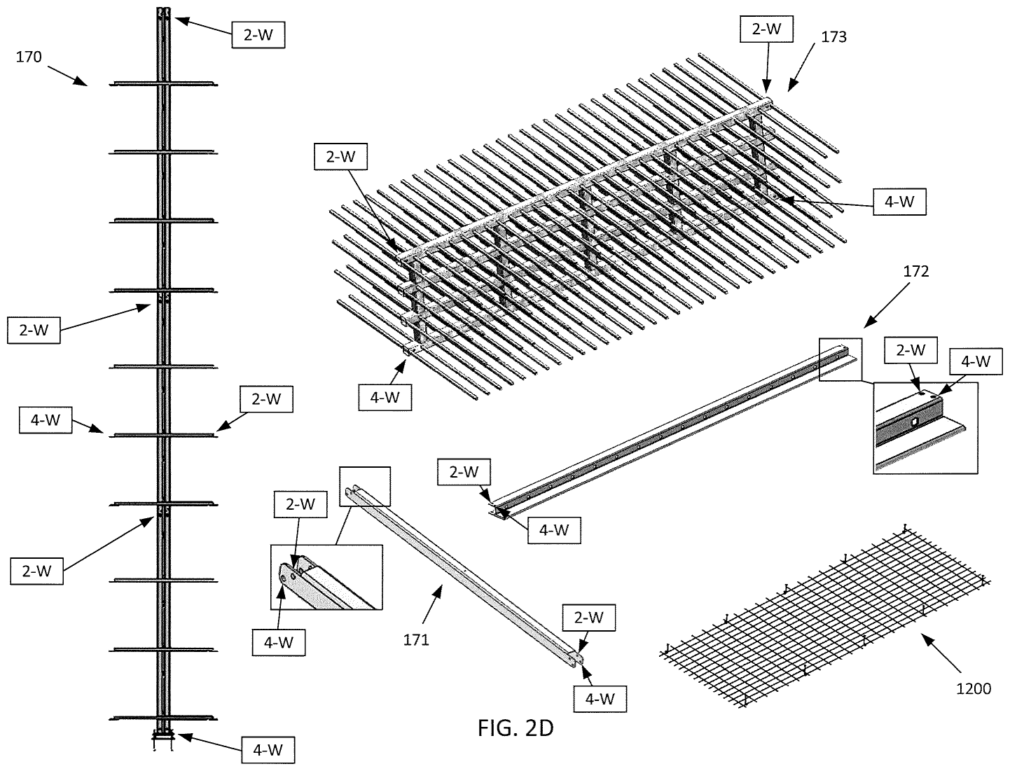

FIGS. 1A, 1B, and 2A-2D illustrate an exemplary material handling system (also referred to as an automatic store and retrieval system) 100 having store racks (see storage rack modules RM) and self-navigating automatic robots (also referred to herein as container bots) 110 in accordance with aspects of the present disclosure. The automatic store and retrieval system may be disposed in a warehouse 199 or in any other suitable location. Although the aspects of the present disclosure will be described with reference to the drawings, it should be understood that the aspects of the present disclosure can be embodied in many forms. In addition, any suitable size, shape or type of elements or materials could be used. It is noted that spatial/directional identifiers such as upper, lower, vertical, horizontal, etc. are used herein for ease of explanation only and that any suitable spatial/directional identifiers may be used.

In accordance with the aspects of the present disclosure, a storage structure 130, of the automatic store and retrieval system 100, includes a bot-shelf structure (referred to herein as a shelving structure) 130SH that has a modular architecture. The shelving structure 130SH includes an array RMA of the store racks RM and bot traverse aisles (also referred to as picking aisles) 130A juxtaposed with the store racks RM. As will be described herein, the picking aisles 130A provide the self-navigating automatic robots 110 with access to the store racks RM, where the store racks RM and picking aisles 130A of the array RMA of store racks RM are integrated into an assembly 130SHA with one or more elevated (or stacked) levels 130L. Each of the levels 130L has a different corresponding predetermined bot traverse reference level BTRL.

The bot traverse reference level BTRL may be a common reference (or datum) corresponding to each level 130L of the assembly 130SHA or a reference level (or datum) particular to a respective level 130L. The term “datum” as used herein is defined as a theoretically exact plane, axis, or point, that is determined from real tangible features on a part (e.g., such as a surface of the part, holes or other features of a post, rail, etc. of the assembly 130SHA, a surface or feature of a lift 150 or transfer deck 130, or any other suitable feature(s) of the storage and retrieval system 100) where measurement equipment physically touches or measures. In other words, a datum is a controlled physical feature of reference (e.g., a corner or fulcrum formed by two sides, a controlled flat surface, a center described by a radiused or curved perimeter of a hole, etc.) for locating one feature relative to another feature. Here, the bot traverse reference level BTRL may be the surface of the given level 130L, a surface at which or on which the self-navigating automatic robots 110 traverse at each respective level 130L (e.g., a height of the bot traverse reference level BTRL, for each level 130L and throughout the level 130L, may be determined/referenced from a base common datum of the storage and retrieval system 100 such as a reference input/output station, holes or other features of a post, rail, etc. of the assembly 130SHA, a surface or feature of a lift 150 or transfer deck 130, or any other suitable feature(s) of the storage and retrieval system 100, where the base common datum and each bot traverse reference level BTRL are correspondingly positioned in a predetermined manner relative to each other). Here, for description purposes, the bot traverse reference level BTRL is described by the riding surface of the self-navigating automatic robots 110 in the picking aisles 130A of each level 130L.

As described herein, the assembly 130SHA includes a first type of structure module 170-173 or frame upright structure module 170, and a second type of structure module 170-173 or lateral structure module 171-173 that is connected to the first type of structure module 170-173 or frame upright structure module 170. The first type of structure module is any one of the types of modules 170-173 and the second type of structure module is a different one of the types of modules 170-173.

The first type of structure module 170-173 or frame upright structure module 170 defines a module part of the array RMA. The assembly 130SHA having more than one of the first type of structure module or frame upright structure module (e.g., there is more than one of module 170, noting there is also more than one of module 171, more than one of module 172, and more than one of module 173). Each of the first type of structure module or frame upright structure module is interchangeable with each other (e.g., modules 170 are interchangeable with other modules 170, also noting modules 171 are interchangeable with other modules 171, modules 172 are interchangeable with other modules 172, and modules 173 are interchangeable with other modules 173). Each of the first type of structure module 170-173 or frame upright structure module 170 has an integral structural datum feature (as described herein) determining the predetermined bot traverse reference level BTRL of each level 130L (see BTRL₁-BRTLᵢ) of the array RMA so that each placement, in the assembly 130SHA, of the first type of structure module repeatably determines the predetermined bot traverse reference level BTRL throughout the array RMA at each level 130L.

The second type of structure module 170-173 or lateral structure module 171-173 is connected to the first type of structure module 170-173 or frame upright structure module 171-173.

The second type of structure module 170-173 or lateral structure module 171-173 is a different type than the first type of structure module 170-173 or frame upright structure module 170 (e.g., where shelf module 170 is the first type of structure module, one or the shelf modules 171-173 is the second type of structure module; where shelf module 171 is the first type of structure module, one or the shelf modules 170, 172, 173 is the second type of structure module; etc.), and defines a different module part of the array RMA.

The second type of structure module 170-173 or lateral structure module 171-173 has control features (as described herein) having a predetermined relationship with the integral structural datum feature (as described herein) of the first type of structure module 170-173 or frame upright structure module 170. The control features being configured so that each second type of structure module 170-173 or lateral structure module 171-173 is interchangeable with each other second type of structure module 170-173 or lateral structure module 171-173 (e.g., modules 170 are interchangeable with other modules 170, modules 171 are interchangeable with other modules 171, modules 172 are interchangeable with other modules 172, and modules 173 are interchangeable with other modules 173), and defines position determining features that finally and repeatably position and align the second type of structure module 170-173 or lateral structure module 171-173, relative to the predetermined bot traverse reference level BTRL, on installing the second type of structure module 170-173 or lateral structure module 171-173 in the assembly 130SHA forming the array RMA.

As will be described herein, the second type of structure module 170-173 or lateral structure module 171-173 is joined to the first type of structure module 170-173 or frame upright structure module 170, and the second type of structure module 170-173 or lateral structure module 171-173 depends from the first type of structure module 170-173 or frame upright structure module 170. As will also be described herein, each second type of structure module 170-173 or lateral structure module 171-173 at each level 130L of the array RMA is substantially automatically aligned with each other second type of structure module 170-173 or lateral structure module 171-173 along the level 130L of the array RMA and relative to the bot traverse reference level BTRL.

Here, for example, the shelving structure 130SH includes different structural shelving elements or module types 170-173, collectively referred to herein as modules 170-173 (see, e.g., FIGS. 2A and 2B, e.g., exclusive of bolts, nuts, clips, and other fastening hardware) that simplify the shelving structure 130SH and decrease setup, dimensional validation, and commissioning time. As will be described herein, the modules 170-173 are also configured to increase storage density of the storage structure 130 by providing substantially continuous or uninterrupted storage shelves along each picking aisle 130A of the shelving structure 130SH (e.g., the shelving support structure does not occupy space between goods (e.g., warehouse packs or case units CU) arranged along the same (i.e., common) storage shelf).

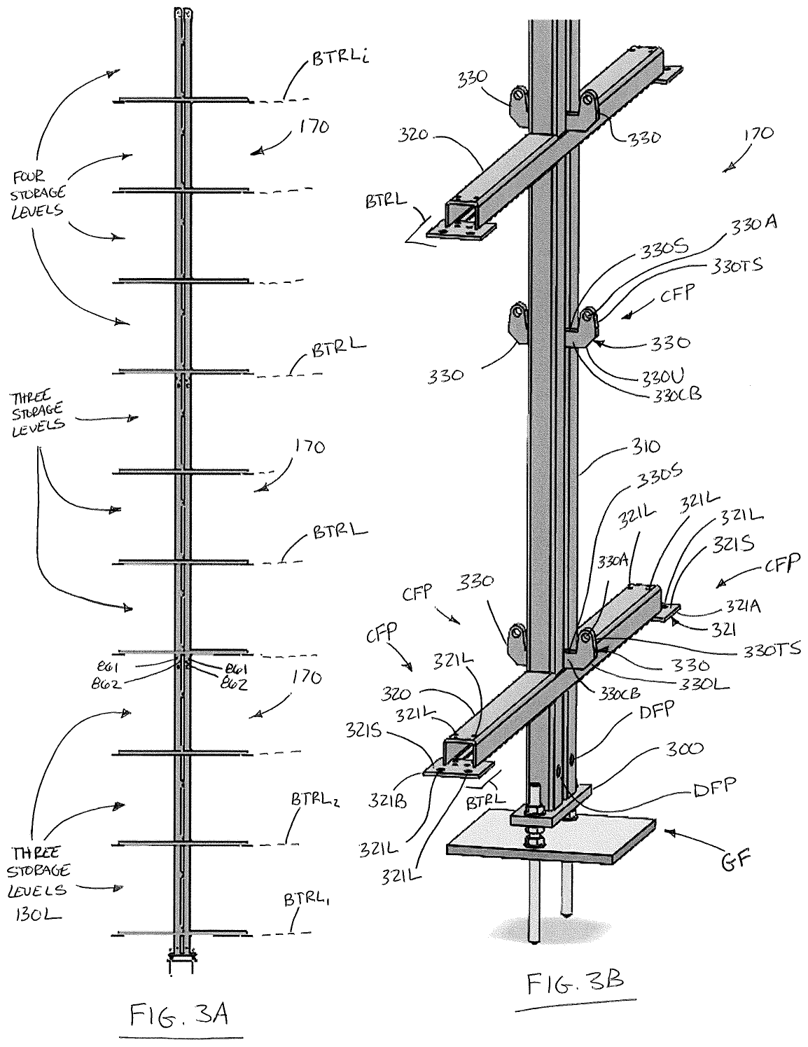

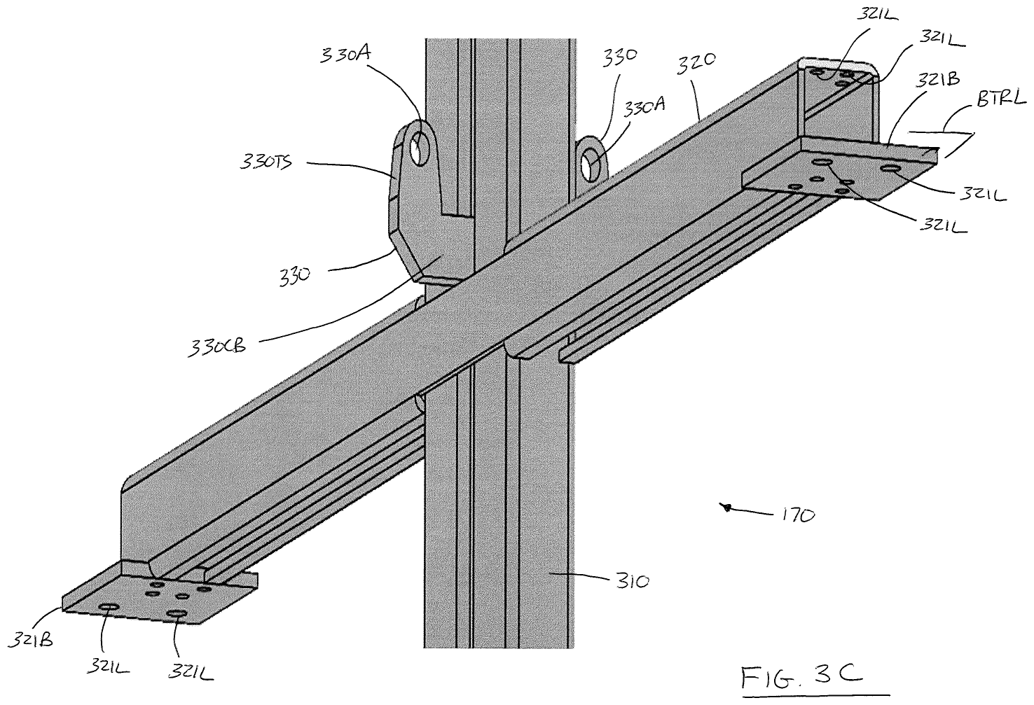

As will be described in greater detail herein, the modules 170-173 are constructed with control features CFR, CFB, CFP, CFS (which are precision location features that may be formed by laser cutting, computer numerical control (CNC) machining, or in any other suitable manner—see, e.g., FIGS. 3B, 4A, 5, 6A, and 6C) that facilitate self-alignment an final positioning of the modules 170-173 relative to each other on assembly. The control features also effect “alignment pin” type tolerances (e.g., interference fit or near-interference fit tolerances, such as one or more of location fit tolerances, similar fit tolerances, fixed fit tolerances, press fit tolerances, driving fit tolerances, and forced fit tolerances—such “alignment pin” type tolerances being referred to herein as fit-up tolerances) between the modules 170-173 so that the entire shelving structure 130SH is a “no adjustment structure” (i.e., the self-aligning modules 170-173, including the control features, lack adjustment (i.e., are automatically finally positioned and aligned) on assembly and effect an adjustment free assembly of the shelving structure 130SH as described herein).

As described herein, the control features CFR, CFB, CFP, CFS are configured so that final and repeatable position and alignment is effected substantially automatically on installation of the second type of structure module 170-173 or lateral structure module 171-173 in the assembly 130SHA. As will also be described herein, the control features CFR, CFB, CFP, CFS are configured so that final and repeatable position and alignment is effected substantially coincident with installation of the second type of structure module 170-173 or lateral structure module 171-173 in the assembly 130SHA.

The fit-up tolerances of the shelving structure 130SH may reduce vibration induced by and transferred to self-navigating automatic robots 110 travelling at high speed (e.g., about 8 meters per second or faster) along storage aisles 130A of the shelving structure 130SH, which may reduce wear and tear on one or more of the self-navigating automatic robots 110 and the shelving structure 130SH. The reduced vibration may also effect a reduction of misplaced warehouse packs CU on the shelves of the shelving structure 130SH, which may improve overall operational efficiency of the automatic store and retrieval system 100. The modularity and adjustment-free assembly of the shelving structure 130SH may also reduce on-site bill of material complexity, reducing a skill level and/or training of the installer. The increased storage density provided by the shelving structure 130SH may reduce a size of the storage structure 130 (and correspondingly reduce a size of facility housing the storage structure 130), which may reduce one or more of initial investment in establishing the automatic store and retrieval system 100 and operating costs when compared to conventional automatic store and retrieval systems that include support structures that divide the storage shelving along the same aisle into separate sections.

It is noted that while the shelving structure 130SH is described herein with respect to a multilevel automatic store and retrieval system 100, employing self-navigating automatic robots 110 confined to respective levels of the multilevel automatic store and retrieval system 100, it should be understood that the aspects of the present disclosure may be applied equally to storage facilities employing stacker cranes, single level storage, and/or multilevel storage and retrieval system having autonomous transport vehicles that travel between different levels of a multilevel storage structure. It should also be understood that while shelving structure 130SH is described with respect to picking aisles 130A extending from a transfer deck 130DC for the self-navigating automatic robots 110 (as described herein), the shelving structure 130SH may also be employed at one or more of: a putwall 263W interfacing between the self-navigating automatic robots 110 and a breakpack module 266 (as described herein); transfer stations TS; and buffer stations BS.

In accordance with aspects of the present disclosure, referring again to FIG. 1A, the automatic store and retrieval system 100 includes input stations 160IN (which include depalletizers 160PA and/or conveyors 160CA for transporting items (e.g., inbound supply containers) to lift modules 150A for entry into a storage level 130L of the storage structure or multilevel container storage array 130SA) and output stations 160UT, 160EC (which include palletizers 160PB, operator stations 160EP and/or conveyors 160CB for transporting items (e.g., outbound supply containers and filled breakpack goods (order) containers) from lift modules 150B for removal from storage (e.g., to a palletizer (for palletizer load) or to a truck (for truck load)). Here the output station 160EC is an individual fulfillment (or e-commerce) output station where, for example, filled breakpack goods (order) containers including single goods items and/or small bunches of goods are transported for fulfilling an individual fulfillment order (such as an order placed over the Internet by a consumer). The output station 160UT is a commercial output station where large numbers of goods are generally provided on pallets for fulfilling orders from commercial entities (e.g., commercial stores, warehouse clubs, restaurants, distribution centers (e.g., where goods, such as the breakpack goods, case units, pickfaces, etc. are held for shipment to individual customers), etc.). As may be realized, the automatic store and retrieval system 100 includes both the commercial output station 160UT and the individual fulfillment output station 160EC; while in other aspects, the automatic store and retrieval system includes one or more of the commercial output station 160UT and the individual fulfillment output station 160EC.

The automatic store and retrieval system 100 also includes input and output vertical lift modules 150A, 150B (generally referred to as lift modules 150—it is noted that while input and output lift modules are shown, a single lift module may be used to both input and remove case units from the storage structure), a storage structure 130 (which may have at least one elevated storage level (also referred to herein as an elevated storage and transport level) and in some aspects forms a multilevel storage array 130SA), and at least one autonomous guided container transport vehicle or container bot 110 which may be confined to a respective storage level of the storage structure 130 and are distinct from a transfer deck 130DC (also referred to herein as a transport area) on (or in) which they travel. It is noted that the depalletizers 160PA may be configured to remove case units from pallets PAL so that the input station 160IN can transport the items to the lift modules 150 for input into the storage structure 130. The palletizers 160PB may be configured to place items removed from the storage structure 130 on pallets PALO for shipping. As used herein the lift modules 150, storage structure 130, breakpack modules 266, goods bots 262, and container bots 110 may be collectively referred to herein as the multilevel automated storage system (e.g. storage and sorting section) noted above so as to define (e.g. relative to a container bot 110 frame of reference or any other suitable storage and retrieval system frame of reference) transport/throughput axes (in e.g. three dimensions) that serve the three dimensional multilevel automated storage system where each throughput axis has an integral “on the fly sortation” (e.g. sortation of case units during transport of the case units) so that case unit sorting and throughput occurs substantially simultaneously without dedicated sorters as described in U.S. Pat. No. 9,856,083, previously incorporated herein by reference in its entirety and U.S. patent application Ser. No. 18/323,758 filed May 25, 2023 (and published as US 2023/0382644 on Nov. 30, 2023), the disclosure of which is incorporated herein by reference in its entirety.

Referring to FIGS. 1A and 1B, the storage structure 130 may include a container autonomous transport travel loop(s) 233, 233A (e.g., formed on and along a container transfer deck 130DC), disposed at a respective level of the storage structure 130. It is noted that the lifts 150 are connected via transfer stations TS (also referred to herein as container infeed stations when the lift 150 is an inbound lift 150A or as container outfeed stations when the lift 150 is an outbound lift 150B, which transfer station TS may be constructed in a manner similar to the shelving structure 130SH described herein) to the container transfer deck 130DC, and each lift is configured to lift one or both of supply containers 265 (empty or filled) and the breakpack goods containers 264 (empty or filled, where a filled breakpack goods container 264 is one that is ready for shipping and is filled so that the breakpack goods BPG within the container occupy at least about 30% or at least about 50% of the total container volume) into and out of the at least one elevated storage level 130L of the storage structure 130. An array of storage shelves 130SA (e.g., forming at least a portion of a storage area of the storage structure 130, including the shelving structure 130SH described herein, and also referred to herein a multilevel container storage array) is configured with container storage locations (or spaces) 130S that are arrayed peripherally along the container transfer deck 130DC, where the transport area of the storage structure 130 is substantially continuous and includes at least the transfer deck 130DC and picking aisles 130A such that the transfer area communicably connects each storage shelf in the array of storage shelves 130SA to each other. For example, multiple storage rack modules RM (FIG. 1B), configured in a high-density three dimensional rack array RMA (including the shelving structure 130SH described herein), are accessible by storage or deck levels 130L. As used herein the term “high-density three dimensional rack array” refers to the three dimensional rack array RMA having substantially uninterrupted undeterministic open shelving distributed along picking aisles 130A where, in some aspects, multiple stacked shelves are accessible from a common picking aisle travel surface or picking aisle level as described in U.S. Pat. No. 9,856,083, previously incorporated by reference herein in its entirety.

Each storage level 130L includes pickface storage/handoff spaces 130S (referred to herein as storage spaces 130S or container storage locations 130S) arrayed substantially uninterrupted peripherally along the container transfer deck 130DC. In some aspects, at least one of the storage locations 130S is a supply container/warehouse pack CU) storage location 130SS, and another of the container storage locations is a breakpack goods (or order) container storage location 130SB. The storage spaces 130S are in one aspect formed by the rack modules RM where the rack modules RM include shelves 630 that are disposed along storage or picking aisles 130A (that are connected to the container transfer deck 130DC) which, e.g., extend linearly through the rack module array RMA and provide container bot 110 access to the storage spaces 130S and transfer deck(s) 130DC (e.g., the container bots 110 are configured to traverse the container transfer deck 130DC and picking aisles 130A on each respective level(s) and transport containers (such as those described herein) accessed to and from container storage locations/spaces (such as described herein) on each of the storage shelves on each respective level(s) of the storage structure 130 to a breakpack operation station 140 or any other suitable location (e.g., transfer station TS, buffer station BS, another storage space 130S, a lift module 150, etc.). In one aspect, the shelves 630 of the rack modules RM are arranged as multi-level shelves that are distributed along the picking aisles 130A. As may be realized the container bots 110 travel on a respective storage level 130L along the picking aisles 130A and the container transfer deck 130DC for transferring case units between any of the storage spaces 130S of the storage structure 130 (e.g. on the level which the container bot 110 is located) and any of the lift modules 150 (e.g. each of the container bots 110 has access to each storage space 130S on a respective level and each lift module 150 on a respective storage level 130L).

The container transfer decks 130DC are arranged at different levels (corresponding to each level 130L of the storage and retrieval system) that may be stacked one over the other or horizontally offset, such as having one container transfer deck 130DC at one end or side RMAE1 of the storage rack array RMA or at several ends or sides RMAE1, RMAE2 of the storage rack array RMA as described in, for example, U.S. Pat. No. 10,822,168 issued on Nov. 3, 2020 the disclosure of which is incorporated herein by reference in its entirety. The container transfer decks 130DC are substantially open and configured for the undeterministic traversal of container bots 110 along multiple travel lanes across and along the transfer decks 130B. As described in U.S. Pat. No. 10,556,743 issued on Feb. 11, 2020, the disclosure of which is incorporated herein by reference in its entirety, the multiple travel lanes may be configured to provide multiple access paths or routes to each storage location 130S (e.g., pickface, case unit, container, or other items stored on the storage shelves of rack modules RM) so that container bots 110 may reach each storage location using, for example, a secondary path if a primary path to the storage location is obstructed. As may be realized, the transfer deck(s) 130B at each storage level 130L communicate with each of the picking aisles 130A on the respective storage level 130L.

Container bots 110 bi-directionally traverse between the container transfer deck(s) 130DC and picking aisles 130A on each respective storage level 130L so as to travel along the picking aisles and access the storage spaces 130S disposed in the rack shelves alongside each of the picking aisles 130A (e.g. container bots 110 may access storage spaces 130S distributed on both sides of each aisle 130A such that the container bot 110 may have a different facing when traversing each picking aisle 130A, for example, drive wheels of the container bot 110 leading a direction of travel or drive wheels trailing a direction of travel). As may be realized, throughput outbound from the storage array 130SHA in the horizontal plane corresponding to a predetermined storage or deck level 130L is effected by and manifest in the combined or integrated throughput along both X and Y throughput axes of the storage and retrieval system (see reference frame REFZ in FIG. 1B). As noted above, the container transfer deck(s) 130DC also provides container bot 110 access to each of the lifts 150 on the respective storage level 130L where the lifts 150 feed and remove case units (e.g. along the Z throughput axis—see reference frame REFZ FIG. 1B) to and/or from each storage level 130L and where the container bots 110 effect case unit transfer between the lifts 150 and the storage spaces 130S.

The container bots 110 may be any suitable independently operable self-navigating automatic robots that respectively carry and transfer/transport case units and/or pickfaces (which may be individually or collectively referred to as supply containers 265) and breakpack goods containers 264, e.g., along the X and Y throughput axes (see FIG. 1B) throughout the storage and retrieval system 100. In one aspect the container bots 110 are automated, independent (e.g. free riding) autonomous transport vehicles. Suitable examples of self-navigating automatic robots can be found in, for exemplary purposes only, U.S. Pat. No. 10,822,168 issued on Nov. 3, 2020; U.S. Pat. No. 8,425,173 issued on Apr. 23, 2013); U.S. Pat. No. 9,561,905 issued on Feb. 7, 2017; U.S. Pat. No. 8,965,619 issued Feb. 24, 2015; U.S. Pat. No. 8,696,010 issued on Apr. 15, 2014; U.S. Pat. No. 9,187,244 issued Nov. 17, 2015; U.S. Pat. No. 11,078,017 issued on Aug. 3, 2021; U.S. Pat. No. 9,499,338 issued on Nov. 22, 2016; U.S. Pat. No. 10,894,663 issued on Jan. 19, 2021; and U.S. Pat. No. 9,850,079 issued on Dec. 26, 2017, the disclosures of which are incorporated by reference herein in their entireties. The container bots 110 (described in greater detail below) may be configured to place case units, such as the above described retail merchandise, into picking stock in the one or more levels of the storage structure 130 and then selectively retrieve ordered case units. As may be realized, in one aspect, the throughput axes X and Y (e.g. pickface transport axes-see frame of reference REFZ in FIG. 1B) of the storage array 130SA are defined by the picking aisles 130A, at least one container transfer deck 130DC, the container bot 110 and an extendable end effector of the container bot 110 (and in other aspects the extendable end effector of the lifts 150 also, at least in part, defines the Y throughput axis). The pickfaces (which in one aspect include supply containers 265) are transported between an inbound section of the storage and retrieval system 100, where pickfaces inbound to the array are generated (such as, for example, input station 160IN) and a load fill section of the storage and retrieval system 100 (such as for example, output station 160UT or output station 160EC), where outbound pickfaces from the array are arranged to fill a load in accordance with a predetermined load fill order sequence or an individual fulfillment order(s) in accordance with a predetermined individual fulfillment order sequence. In another aspect, pickfaces (e.g., of supply containers 265) are transported between the storage spaces 130S and a load fill section of the storage and retrieval system 100 (such as for example, output station 160UT or output station 160EC) to fill a load in accordance with a predetermined load fill order sequence or an individual fulfillment order(s) in accordance with a predetermined individual fulfillment order sequence. In still other aspects, breakpack goods container(s) 264 (which, in one aspect, multiple breakpack goods containers may be arranged in and transported as a pickface) are transported by the container bots 110 between the storage spaces 130S and the load fill section and/or between the breakpack goods interface 263 of the breakpack module(s) 266 and the load fill section of the storage and retrieval system 100 (such as for example, output station 160UT or output station 160EC) to fill a load in accordance with a predetermined load fill order sequence or an individual fulfillment order(s) in accordance with a predetermined individual fulfillment order sequence. The control server 120 may operate the automatic store and retrieval system 100 in different modes of operation so that the pickfaces (e.g., of supply containers 265) and breakpack goods containers 264 are transferred in accordance with one or more of the above aspects to the load fill section to fill a load with one or more of pickfaces (e.g., of supply containers 265) and breakpack goods containers 264.

As described above, referring to FIG. 1B, in one aspect the storage structure 130 includes multiple storage rack modules RM (including the shelving structure 130SH described herein), configured in a three dimensional array RMA (e.g., forming the array 130SHA of storage shelves 630) where the racks are arranged in aisles 130A, the aisles 130A being configured for container bot 110 travel within the aisles 130A. The container transfer deck 130DC has an undeterministic transport surface that may be coplanar with the bot traverse reference level BTRL on which the container bots 110 travel where the undeterministic transport surface (also referred to herein as a deck surface) 130BS has multiple travel lanes (e.g., more than one juxtaposed travel lane (e.g. high speed bot travel paths HSTP)) for travel of the container bot 110 along the container autonomous transport travel loop(s) 233 formed by the container transfer deck 130DC, where the multiple travel lanes connect the aisles 130A. The container autonomous transport travel loop(s) 233 provides the container bot 110 with random access to any and each picking aisle 130A and random access to any and each lift 150A, 150B on the respective level 130L of the storage structure 130. At least one of the multiple travel lanes has a travel sense opposite to another travel lane sense of another of the multiple travel lanes (so as to form the container autonomous transport travel loop 233).

In one aspect, the storage rack modules RM and the container bots 110 are arranged so that in combination the storage rack modules RM and the container bots 110 effect the on the fly sortation (e.g., such as of the pallet output sort 185 echelon) of mixed case pickfaces coincident with transport on at least one (or in other aspects on at least one of each of the more than one) of the throughput axes so that two or more pickfaces are picked from one or more of the storage spaces and placed at one or more pickface holding locations (such as, for example, the buffer and transfer stations BS, TS), that are different than the storage spaces 130S, according to the predetermined load fill order sequence.

As may be realized, any suitable controller of the storage and retrieval system 100 such as for example, control server 120, may be configured to create any suitable number of alternative pathways or diverts for retrieving one or more case units (and/or breakpack goods containers) from their respective storage locations 130S when a pathway provided access to those case units is restricted or otherwise blocked in the manner described in U.S. provisional patent application No. 63/044,721 filed on Jun. 26, 2020 and titled “Warehousing System for Storing and Retrieving Goods In Containers,” the disclosure of which was previously incorporated herein by reference in its entirety.

It is noted that the storage and retrieval systems shown and described herein have exemplary configurations only and in other aspects, the storage and retrieval systems may have any suitable configuration and components for storing and retrieving items as described herein. For example, in other aspects, the storage and retrieval system may have any suitable number of storage sections, any suitable number of transfer decks, any suitable number of breakpack modules 266, and corresponding input/output stations.

As may be realized, the juxtaposed travel lanes are juxtaposed along a common undeterministic transport surface 130BS between opposing sides 130BD1, 130BD2 of the container transfer deck 130DC. As illustrated in FIG. 1B, in one aspect the aisles 130A are joined to the container transfer deck 130DC on one side 130BD2 of the container transfer deck 130DC but in other aspects, the aisles are joined to more than one side 130BD1, 130BD2 of the container transfer deck 130DC in a manner substantially similar to that described in U.S. Pat. No. 10,822,168 issued on Nov. 3, 2020, the disclosure of which is previously incorporated by reference herein in its entirety. As described in U.S. provisional patent application No. 63/044,721 filed on Jun. 26, 2020 and titled “Warehousing System for Storing and Retrieving Goods In Containers” and U.S. patent application Ser. No. 17/358,383 filed on Jun. 25, 2021) the disclosures of which were previously incorporated herein by reference in their entireties, the other side 130BD1 of the container transfer deck 130DC may include deck storage racks (e.g. interface stations (also referred to as transfer stations) TS and buffer stations BS) that are distributed along the other side 130BD1 of the container transfer deck 130DC so that at least one part of the transfer deck is interposed between the deck storage racks (such as, for example, buffer stations BS or transfer stations TS) and the aisles 130A. The deck storage racks are arranged along the other side 130BD1 of the container transfer deck 130DC so that the deck storage racks communicate with the container bots 110 from the container transfer deck 130DC and with the lift modules 150 (e.g. the deck storage racks are accessed by the container bots 110 from the container transfer deck 130DC and by the lifts 150 for picking and placing pickfaces so that pickfaces are transferred between the container bots 110 and the deck storage racks and between the deck storage racks and the lifts 150 and hence between the container bots 110 and the lifts 150).

Referring again to FIG. 1A, each storage level 130L may also include charging stations 130C (e.g., located at any suitable container transfer location) for charging an on-board power supply of the container bots 110 on that storage level 130L such as described in, for example, U.S. patents application Ser. Nos. 14/209,086 filed on Mar. 13, 2014 and U.S. Pat. No. 9,082,112 issued on Jul. 14, 2015, the disclosures of which are incorporated herein by reference in their entireties.

Still referring to FIGS. 1A and 1B, in accordance with aspects of the present disclosure the automatic store and retrieval system 100 may operate in a retail distribution center or warehouse to, for example, fulfill orders received from different customers (such as those described herein) for breakpack goods BPG and/or warehouse packs CU. Suitable examples of automatic store and retrieval systems that incorporate or are capable of incorporating breakpack goods systems are described in, for example, U.S. Pat. No. 10,822,168 issued on Nov. 3, 2020; U.S. provisional patent application Ser. No. 17/657,705 filed on Apr. 1, 2022 and titled “Warehousing System for Storing and Retrieving Goods in Containers”; and U.S. provisional patent application Ser. No. 17/358,383 filed on Jun. 25, 2021 and titled “Warehousing System for Storing and Retrieving Goods in Containers”, the disclosures of which are incorporated by reference herein in their entireties.

As an example, the warehouse packs CU are cases or units of goods not stored in trays, on totes or on pallets (e.g. uncontained). In other examples, the warehouse packs CU are cases or units of goods that are contained in any suitable manner such as in trays, on totes, in containers (such as containers of remainder goods after breakpack where the broken down warehouse pack structure is unsuitable for transport of the remainder goods as a unit) or on pallets. In still other examples, the warehouse goods CU are a combination of uncontained and contained items. It is noted that the warehouse packs CU, for example, include cased units of goods (e.g. case of soup cans, boxes of cereal, etc.) or individual goods that are adapted to be taken off of or placed on a pallet. In accordance with the aspects of the present disclosure, shipping cases for warehouse packs CU (e.g. cartons, barrels, boxes, crates, jugs, or any other suitable device for holding case units) may have variable sizes and may be used to hold case units in shipping and may be configured so they are capable of being palletized for shipping.

It is noted that when, for example, bundles or pallets of warehouse packs CU (e.g., mixed product units) arrive at the storage and retrieval system 100 the content of each pallet may be uniform (e.g. each pallet holds a predetermined number of the same item-one pallet holds soup and another pallet holds cereal) and as pallets leave the storage and retrieval system the pallets may contain any suitable number and combination of different warehouse packs CU or containerized product units BPG (e.g. a mixed pallet where each mixed pallet holds different types of warehouse packs and/or containerized product units BPG—a pallet holds a combination of soup and cereal) that are provided to, for example the palletizer in a sorted arrangement for forming the mixed pallet. In the aspects of the present disclosure the storage and retrieval system 100 described herein may be applied to any environment in which warehouse packs CU are stored and retrieved.

Still referring to FIGS. 1A and 1B, in accordance with the aspects of the present disclosure, the automatic store and retrieval system 100 includes one or more breakpack modules 266 (see FIGS. 1A and 1B) configured to break down product containers or warehouse packs CU (which may generally be referred to as supply goods containers or supply containers 265) into breakpack goods containers 264 (which are used for shipping the breakpack goods, e.g., shipping containers) for order fulfillment in a manner similar to that described in U.S. provisional patent application Ser. No. 17/657,705 filed on Apr. 1, 2022 and titled “Warehousing System for Storing and Retrieving Goods in Containers” and U.S. provisional patent application No. 17/358,383 filed on Jun. 25, 2021 and titled “Warehousing System for Storing and Retrieving Goods in Containers”, the disclosures of which were previously incorporated by reference herein in their entireties. In some aspects, the breakpack modules 266 may be omitted.

One or more breakpack modules 266 may be communicably coupled to one or more stacked (storage) levels 130L of the automatic store and retrieval system 100, where the one or more levels 130L of the automatic store and retrieval system 100 include at least one breakpack module 266. The breakpack module(s) 266 may be plug and play modules that may be coupled to any suitable portion of the structure of the automatic store and retrieval system 100. For example, the breakpack module(s) may be coupled to a container transfer deck 130DC (see also container transfer deck 130DC2 in FIG. 1B) or picking (or pick) aisle(s) 130A of the automatic store and retrieval system 100. The breakpack module(s) 266 may be disposed on any suitable number of stacked storage levels of the automatic store and retrieval system 100. The container bot(s) 110 operate between the container storage locations 130S, the breakpack operation station 140, and a breakpack goods container 264 located at a putwall 263W (which may include the shelving structure 130SH described herein) along a breakpack goods transfer deck or goods deck 130DG (e.g., a breakpack goods container 264 located at a breakpack goods interface station/container station 263L of a putwall 263W).

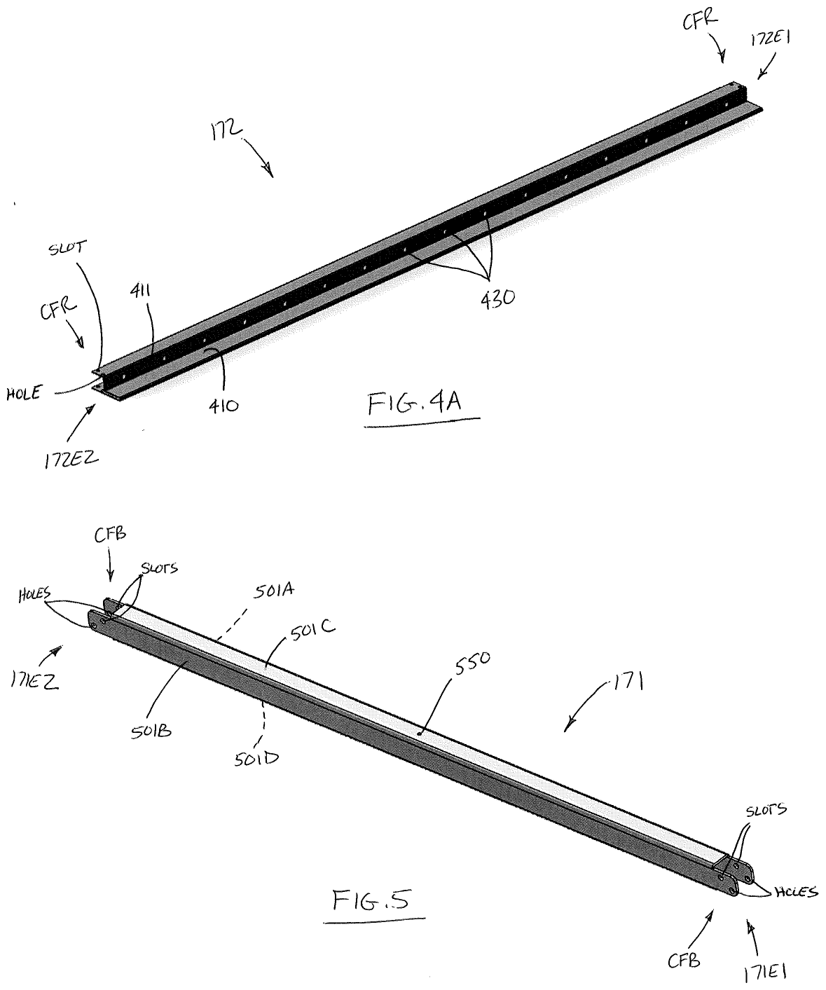

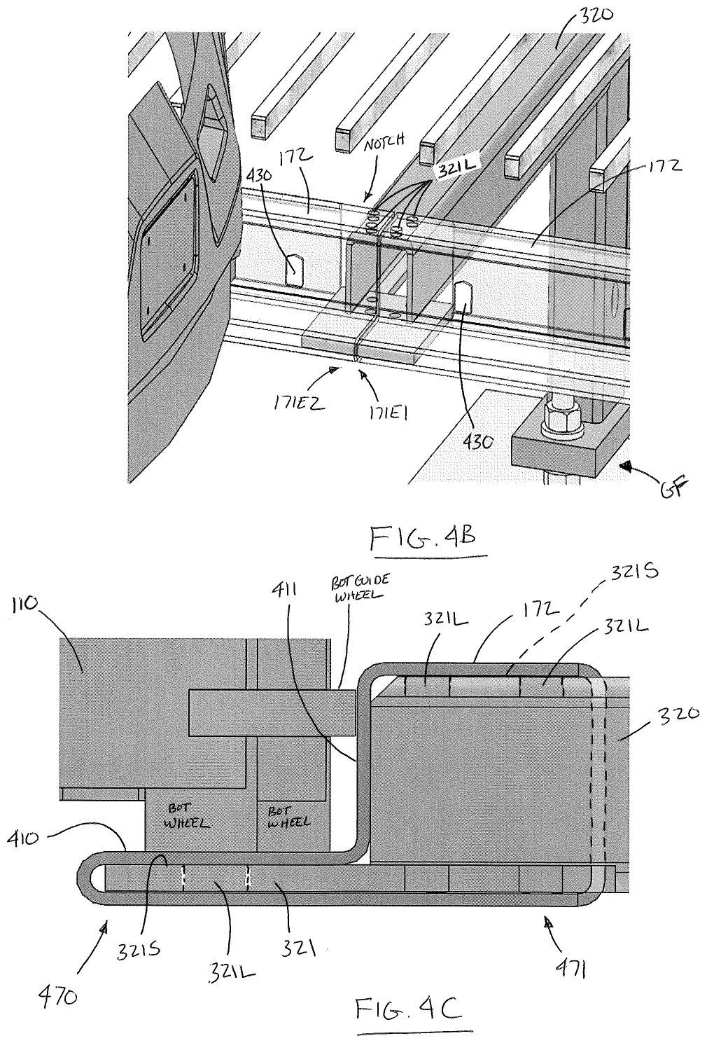

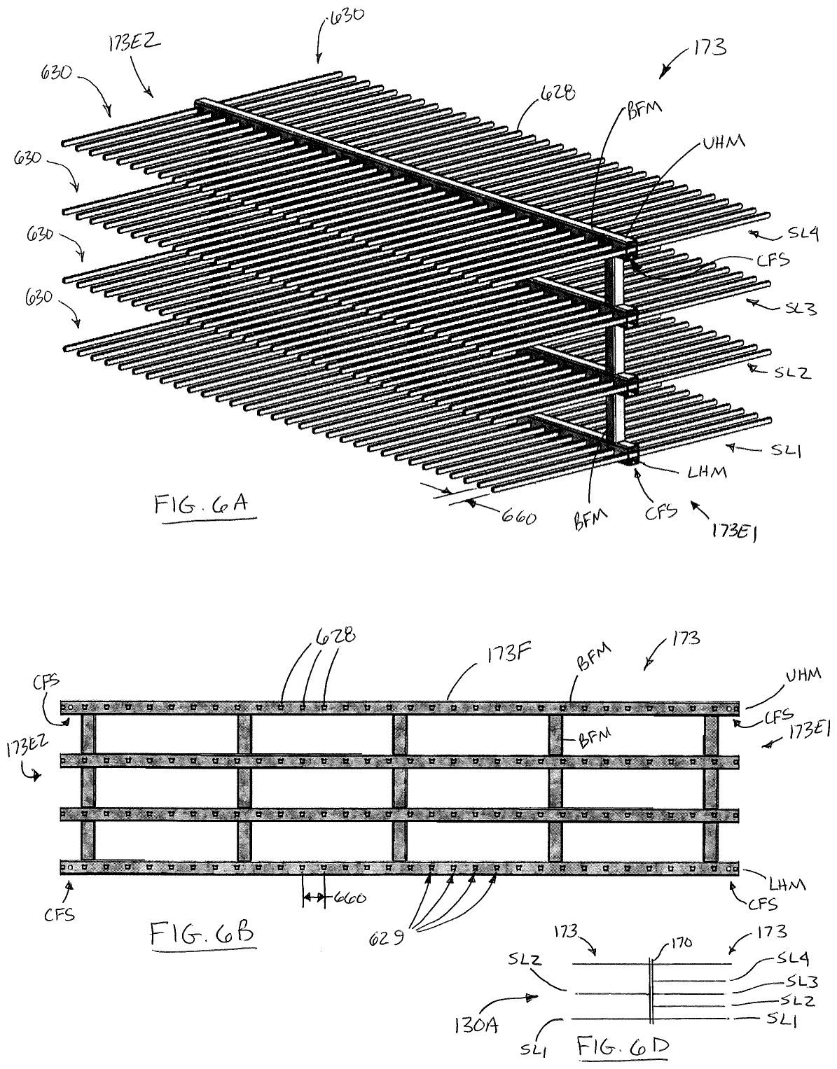

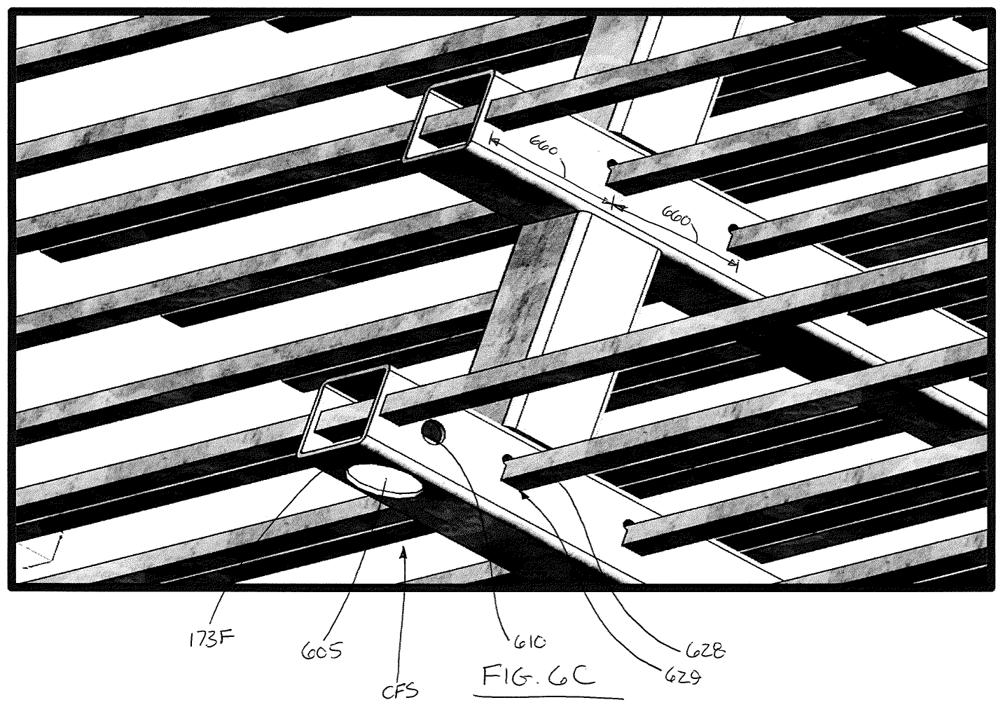

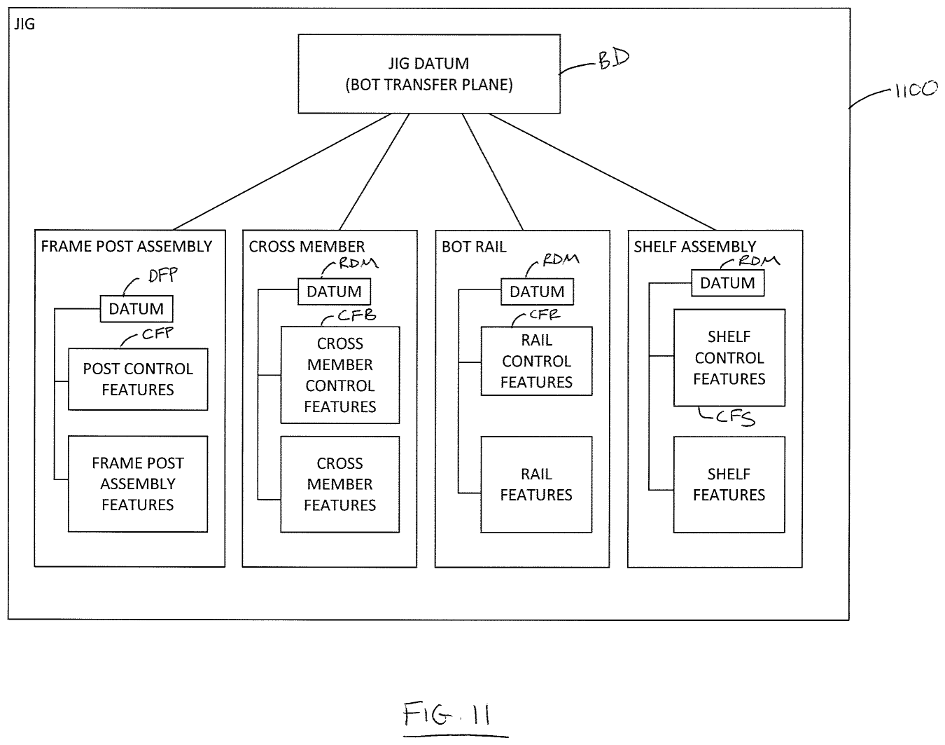

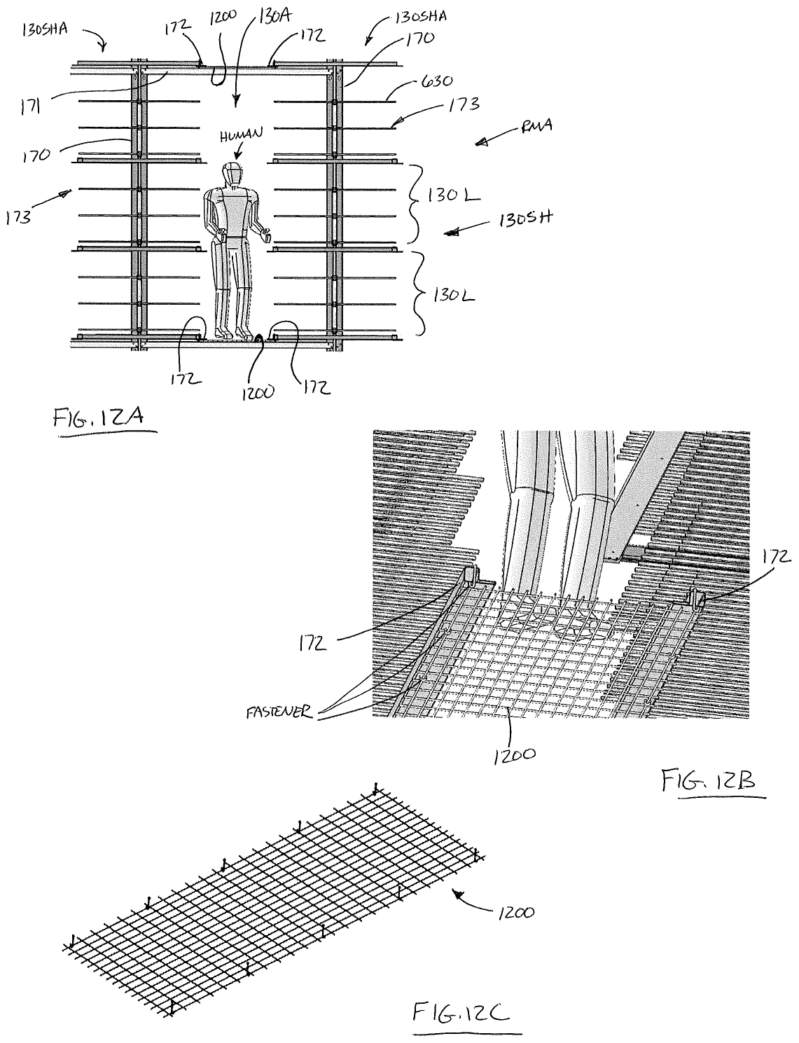

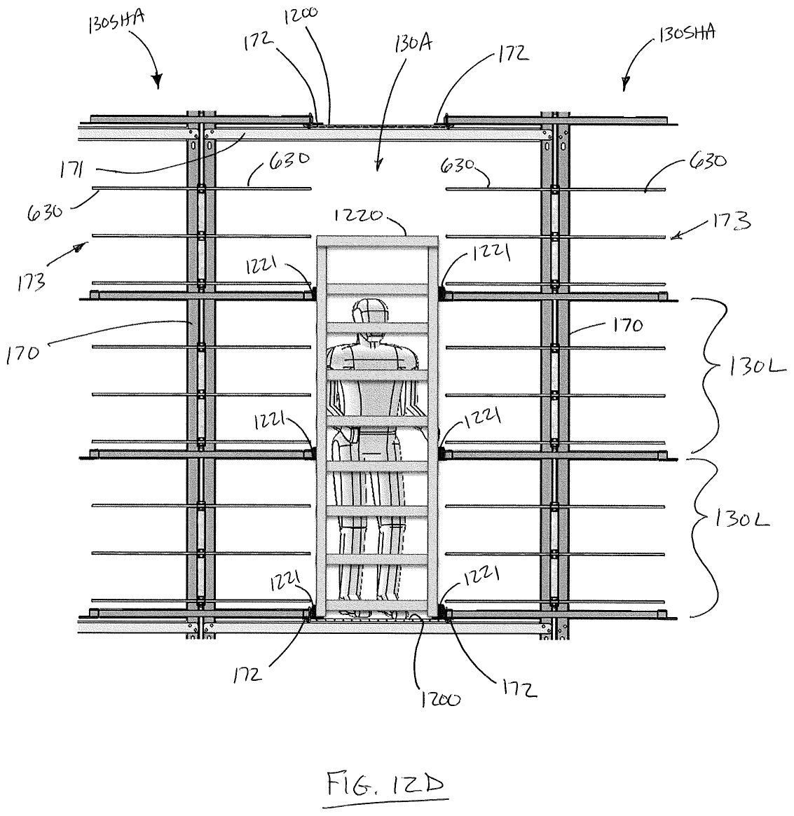

Referring to FIGS. 2A-6C, as noted herein the shelving structure 130SH includes the different structural modules 170-173. Module 170 is a frame post assembly module (and will be referred to herein as a post module or frame upright structure module 170-see FIGS. 3A-3C). Module 171 is a cross-member beam module (and will be referred to herein as a beam module 171—see FIG. 5). Module 172 is a bot rail module (and will be referred to herein as rail module or bot rail 172—see FIGS. 4A-4C). Module 173 is a tine-shelf assembly module (and will be referred to herein as a shelf module or rack shelf assembly 173—see FIGS. 6A-6C). In some aspects, as described herein, a floor module 1200 (see FIG. 12) is also provided. An illustration of the collective modules 170-173, 1200 is shown in FIG. 2D in what may be referred to as an exploded view illustration. As described herein, each structural module 170-173, 1200 of a certain type is interchangeable with another module 170-173 of the same type.

For exemplary purposes, the post modules 170 will be employed as the first type of structural module to describe the final and repeatable positioning and alignment of the modules 171-173 (e.g., at least one of which is the second type of structure module (also referred to as a lateral structure module)) relative to at least the bot traverse reference level BTRL; however, it should be understood that any of the modules 170 (when fixed in space) may be employed for finally and repeatably positioning and aligning the other modules relative to at least the bot traverse reference level BTRL.

The modules 170-173 are configured to be interlocked together so that one module 170-173 depends one from another module 170-173 (e.g., in the X and Y directions—see reference frame REFZ in FIG. 1B) with the control features (having the fit-up tolerances described herein) so as to produce a storage structure bay (see FIG. 2A) geometry that lacks adjustment between the modules 170-173 of a respective storage structure bay so as to effect an adjustment-free assembly whose component parts are automatically finally positioned and aligned on assembly. In some aspects, the shelving structure 130SH also lacks adjustment between the modules 170-173 of adjacent storage structure bays. Here, the shelving structure 130SH as a whole may be set at a predetermined elevation setting (e.g., in the Z direction relative to the reference frame REFZ of the storage and retrieval system 100) by employing levelling features 290 (as described herein, see FIG. 2C) of the respective post modules 170 prior to assembly of the modules 171-173 to the post modules 170.

The control features CFR, CFB, CFS, of at least a respective module 171-173, define a deterministic (kinematic or quasi-kinematic) coupling and the post module 170 has conformal mating features CFP that conform to and mate with the control features CFR, CFB, CFS of the modules 171-173 and effect (as described herein) on mating repeatable deterministic and final positioning of the post module 170 and the modules 171-173 to each other, relative to the bot traverse reference level BTRL, within the assembly 130SHA, on mating. The kinematic or quasi-kinematic couplings are schematically illustrated in FIG. 2D where four-way (four degree of freedom) constraint couplings of each module 170-173 are identified by the “4-W” reference and two-way (two degree of freedom) constraint couplings of each module 170-173 are identified by the “2-W” reference. As described herein, these kinematic or quasi-kinematic couplings prevent over constraint of modules 170-173 of the assembly 130SHA.

Referring to FIGS. 4A-4C, each rail module 172 (also referred to herein as a bot rail) has an elongated frame with closed cross-section (what may be referred to as an L-shaped boxed cross section) but in other aspects, the rail module 172 may have any suitable cross-section. The rail module 172 includes a bot riding surface 410 on which wheels 110W of the self-navigating automatic robots 110 roll (e.g., the self-navigating automatic robots 110 traverse along the rail module 172 on the bot riding surface 410). The rail module 172 also includes a lateral guide surface 411 that is engaged by a bot guide wheel so as to constrain movement of the self-navigating automatic robot 110 to straight line movement within the picking aisle 130A and so that the self-navigating automatic robot 110 is at a predetermined position (e.g., in the Y direction-see FIG. 1B) from the shelves of the shelf modules 173 (see FIGS. 2B, 2C, 4B and 4C). The lateral guide surface 411 may include holes, slots, recesses, or indicia (referred to as bot locating features 430) disposed on, in, or through the lateral guide surface, where the bot locating features 430 are disposed at predetermined locations on the rail module 172 so that when sensed or otherwise detected by an self-navigating automatic robot 110, the self-navigating automatic robot 110 determines its location along a respective picking aisle 130A based at least in part on sensing/detection of the bot locating features 430.

Each end 172E1, 172E2 of the rail module 172 is notched or relieved (a portion of the side of the rail module 172 opposite the bot riding surface 410, adjacent each end 172E1, 172E2, is removed) so that a bot rail support 320 of the post module 170 may be inserted into the rail module 172 as described herein (and shown in, e.g., FIGS. 4B and 4C) for coupling the rail module 172 to the bot rail support 320.

The rail module 172 may include control features CFR (e.g., holes and/or slots) configured to at least locate the rail module 172 relative to a post module 170 (or vice versa). In some aspects, the control features CFR may be employed to couple the rail module 172 to the post module (such as where fasteners (shoulder bolts, dowels pins, etc.) are passed through the control features CFR into the post module 170. The control features CFR, for exemplary purposes, include holes and slots so that the coupling between the rail module 172 and the post module 170 is not over constrained. The control features CFR define kinematic or quasi-kinematic couplings as described herein. The control features CFR may be positioned on (or formed in) the rail module 172 in any suitable manner, such as with a jig 1100 (see FIG. 11) so that the control features CFR have a predetermined spatial relationship with the lateral guiding surface 411 and/or bot riding surface 410. It is noted the jig 1100 may also facilitate formation of the bot locating features 430 in or on the lateral guiding surface 411 in a predetermined spatial relation with the control features CRF.

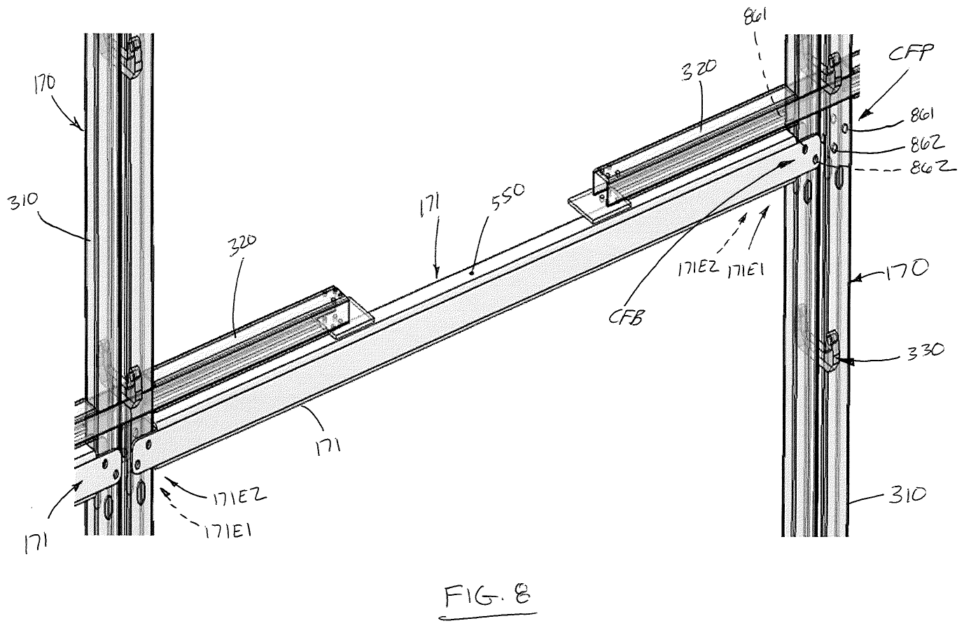

Referring to FIG. 5, each beam module 171 has an elongated frame with a boxed or C-channel cross-section, although in other aspects the beam module 171 may have any suitable cross-section. The ends 171E1, 171E2 of the beam module 171 may be cut so that lateral sides 501A, 501B extend past at least a top side 501C (and where the cross-section is boxed, a bottom side 501D) so as to form a fork that engages corresponding sides of the post module 170 (see FIG. 8). The beam module 171 may have a centerline reference feature 550 (e.g., aperture or other feature) from which a plumb-bob locator may be suspended (e.g., for dimensional validation and commissioning purposes or for any other suitable purpose). The beam module 171 may be symmetrical about is lateral and longitudinal axes so that beam module 171 may be installed between post modules 170 with disregard to its lengthwise orientation (see FIG. 8).

The beam module may include control features CFB (e.g., holes and/or slots) configured to at least locate the beam module 171 relative to a post module 170 (or vice versa). The control features CFB define kinematic or quasi-kinematic couplings as described herein. In some aspects, the control features CFB may be employed to couple the beam module 171 to the post module, such as where fasteners (shoulder bolts, dowels pins, etc.) are passed through the control features CFB into the post module 170. The control features CFB, for exemplary purposes, include holes and slots disposed on each end 171E1, 171E2 of the beam module 171 so that the coupling between the beam module 171 and the post module 170 is not over constrained. The control features CFB may be positioned on (or formed in) the beam module 171 in any suitable manner, such as with a jig 1100 (see FIG. 11).

Referring to FIGS. 6A-6C, the shelf module 173 (also referred to herein as a rack shelf assembly) and the rail module 172 are decoupled from each other within the assembly 130SHA, and independently joined deterministically with respect position determining features (as described herein) of the post module 170 so that pose of the rail module 172 and shelf module 173, relative to each other and to the bot traverse reference level BTRL, is repeatably determined for each installation of the rail module 172 and the shelf module 173.

The shelf module 173 includes an elongated frame or spine (also referred to as a box frame) 173F with box frame members (vertical and horizontal—see, e.g., FIGS. 6A and 6B). The box frame members BFM are separate and distinct from the post module 170. As described herein, the box frame members BFM define supports for more than one rack shelves 630, where each rack shelf 630 is cantilevered from the elongated frame 173F. As described herein, the elongated frame 173F has control features CFS that finally and repeatably position each rack shelf 630 relative to the bot traverse reference level BTRL on installing the shelf module 173 in the array RMA (e.g., in the assembly 130SHA). The control features CFS define kinematic or quasi-kinematic couplings as described herein.

The box frame members BFM have a lattice structure with one or more horizontal members (e.g., at least one horizontal member defining a height of corresponding shelf of a corresponding storage level 130L). The frame 173F may be constructed of horizontal and vertical members having box shaped cross-sections however, in other aspects, the horizontal and vertical members may have any suitable cross-sections. In the exemplary shelf module 173 illustrated in FIGS. 6A-6C the shelf module 173 includes four shelf levels SL1-SL4 (i.e., four shelf levels per storage level 130L that are accessed by a container bot 110 from a common rail module 172) however, in other aspects there may be more or fewer than four shelf levels (e.g., depending on a size of warehouse packs CU to be stored thereon—see FIGS. 2A and 2C illustrating shelf modules 173 having three shelf levels per storage level 130L). In some aspects, shelf modules 173 having a differing number of shelves may be disposed on a same (i.e., a common) side of the same (i.e., common) picking aisle 130A so that a vertical pitch between shelves varies along the same picking aisle 130A (see FIG. 6D) in a manner substantially similar to that described in U.S. Pat. No. 11,130,631 issued on Sep. 28, 2021 (having U.S. patent application Ser. No. 16/788,735 filed on Feb. 12, 2020), the disclosure of which is incorporated herein by reference in its entirety.

The frame 173F has ends 173E1, 173E2, where each end includes control features CFS configured to at least locate the shelf module 173 relative to a post module 170 (or vice versa). In some aspects, the control features CFS may be employed to couple the beam module 171 to the post module, such as where fasteners (shoulder bolts, dowels pins, etc.) are passed through the control features CFS into the post module 170 (or vice versa). The control features CFS, for exemplary purposes, include holes and slots disposed on each end 173E1, 173E2 of the shelf module 173 so that the coupling between the shelf module 173 and the post module 170 is not over constrained. Here, control features CFS may be disposed on a bottom surface of the uppermost horizontal member UHM and lowermost horizontal member LHM of the frame 173F (or any other combination of two horizontal members of the frame). An example control feature CFS of the lowermost horizontal member LHM is illustrated in FIG. 6C and includes an aperture 605 (or any other suitable feature, such as a dowel) arranged to restrict movement of the shelf module 173, with coupling of the shelf module 173 to the post module 170, in the X and Y directions (see reference frame REFZ in FIG. 1B) and aperture 610 arranged to restrict movement of the shelf module in the Z direction (see reference frame REFZ in FIG. 1B). The control feature CFS of the uppermost horizontal member UHM may be substantially similar however, not all constraints are employed (for example, the aperture 610 may not be used or omitted) to prevent over constraint of the coupling between the shelf module 173 and post module 170. The control features CFS may be positioned on (or formed in) the shelf module 173 in any suitable manner, such as with a jig 1100 (see FIG. 11).

The frame 173F of the shelf module 173 includes apertures 629 (e.g., that are laser cut, CNC machined, or suitably precision formed in any other suitable manner) through which a respective shelf tine 628 is inserted to form a respective shelf 630. The apertures 629 are formed in the horizontal members so as to have a predetermined spacing 660 between shelf tines 628. The apertures 629 may be positioned on (or formed in) the frame 173F in any suitable manner, such as with a jig 1100 (see FIG. 11). The shelf tines 628 may have any suitable cross-section including, but not limited to, solid square bar, square tube, solid round bar, hollow round tube, rectangular, channel, I-beam, H-beam, and U-beam cross-sections. The apertures 629 have a shape corresponding to the shelf tines 628 so that the shelf tines 628 extend through the respective aperture 629 and extend on opposite sides of the frame 173F in a cantilevered manner (i.e., the shelf tines form cantilevered shelves 630 extending from opposite sides of the frame 173F-see, e.g., FIG. 6A and 6C) to form what may be referred to as a double-sided storage section however, in other aspects the shelf tines 628 may extend from only one side of the frame 173F so as to form what may be referred to as a single-sided storage section. The fit between a shelf tine 628 and a respective aperture 629 may be an interference fit where the shelf tine 628 is held in place by the interference fit, although in other aspects, the shelf tine 628 may be coupled to the frame 173F, within the aperture 629, in any suitable manner.

Referring to FIGS. 2A, 2B, and 3A-3C, each post module 170 is based on a ground foundation GF, and as described herein, is substantially upright (e.g., extends along the Z axis with reference to reference frame REFZ) so that an integral datum feature DFP of the post module 170 sets the predetermined bot traverse reference level BTRL of each level 130L of the array RMA. The post module 170 is (see at least FIG. 2A) at least a frame upright, post, or pillar (referred to herein as a stanchion 310) that frames and position each of the second type of structure modules (e.g., at least one of modules 171-173).

For example, the post module 170 includes a base 300 and the stanchion 310 extending from the base 300. As described herein, the base is coupled to (and may form a part of) the ground foundation GF by one or more jacking features JF. One or more bot rail supports 320 are coupled to the stanchion 310 at predetermined locations along the stanchion 310. In the aspect illustrated the bot rail support 320 extends from opposite sides of the stanchion 310 (e.g., along the Y direction in the storage and retrieval system 100 reference frame REFZ—see FIG. 1B) so as to form what may be referred to as a double sided storage section (e.g., warehouse packs CU may be stored on opposite sides of the post module 170 however, in other aspects the bot rail supports 320 may extend from only one side of the stanchion 310 so as to form what may be referred to as a single sided storage section (e.g., warehouse packs CU may be stored only on a single side of the post module 170). Distal (cantilevered) ends 321E (e.g., relative to the stanchion 310) of the bot rail support 320 each include a bot rail coupler 321. As described herein the features of the bot rail supports 320 finally and repeatably position and align the rail modules 172 relative to at least one or more the bot traverse reference level BTRL and the reference frame REFZ.

For example, the bot rail coupler 321 includes a rail seating surface 321S (disposed at a predetermined spatial location relative to an integral structural datum feature DFP of the post module) that automatically establishes a height (e.g., in the Z direction) of a rail module 172, seated thereon, relative to a reference frame (such as one or more of the bot traverse reference level BTRL, the datum feature DFP of the post module, and the reference frame REFZ of the storage and retrieval system 100) upon coupling of the rail module 172 to the bot rail coupler 321. One or more of the bot rail coupler 321 and distal end 321E includes locating features 321L (e.g., apertures) that align with respective control features CFR (e.g., apertures, slots, surfaces, etc.) of the rail module 172 for locating the rail module 172 in one or more of the X and Y directions in the reference frame REFZ. The locating surface 321S and apertures 321L are control features CFP of the post module 170 (e.g., that define kinematic or quasi-kinematic couplings as described herein) that deterministically (e.g., in a kinematic (six degree of freedom restraint) or quasi-kinematic (less than six degree of freedom constraint) manner) locate a respective rail module 172 relative to at least to one or more of the datum feature DFP and the other modules 170-173 of the shelving structure 130SH.

As an example, referring also to FIGS. 4B and 4C, coupling of a rail module 172 to a bot rail support 320 includes fitting the rail module 172 over the bot rail support 320 so that the bot rail coupler 321 is inserted into a riding surface portion 470 of the rail module 172 and the end of the bot rail support 320 is inserted into a rail portion 471 of the rail module 172. The rail seating surface 321S is in substantial contact with an underside of the bot riding surface 410 so as to set the Z height (see reference frame REFZ in FIG. 1B) of the bot riding surface 410. The apertures 421L align with corresponding apertures (e.g., the slot and hole—see FIG. 4A) of the rail module 172 so as to constrain the X and Y (and rotational) location (see reference frame REFZ) of the rail module 172 relative to post module 170 (and the other modules of the shelving structure 130SH.

It is noted, as illustrated in FIG. 4B, the bot rail coupler 321 spans between the ends 171E1, 171E2 of adjacent rail modules 172 such that the Z axis constraint provided by the bot rail coupler 321 on the bot riding surfaces 410 of the adjacent rail modules 172 may substantially eliminate any bumps or discrepancy in height between the bot riding surfaces 410 if the adjacent rail modules 172 so as to reduce vibration induced by the self-navigating automatic robot 110 on the storage structure 130 and any vibration induced in the self-navigating automatic robot 110 caused by traverse over uneven surfaces of the storage structure 130. It is further noted that post module 170, via the bot rail support 320, supports the rail module 172 independent of the storage shelves so that loading on the storage shelves may not affect the bot riding surface 410, and loading on the bot riding surface 410 may not affect warehouse packs CU seated on the shelves of the shelf modules 173.

The predetermined location of the bot rail coupler 321 along the stanchion 310 may be established from an integral structural datum feature DFP of the post module (e.g., such as an aperture, surface, etc.) in any suitable manner, such as by employment of an assembly jig 1100 (see FIG. 11), so that the control features CFP are located at predetermined positions relative to the datum feature DFP.

The post module 170 also includes shelf supports 330, disposed thereon in predetermined spatial relationship relative to the datum feature DFP, that are configured to deterministically locate (e.g., in a kinematic or quasi-kinematic manner) a respective shelf module 173 relative to the other modules 170-173 of the shelving structure 130SH by finally and repeatably positioning and aligning the shelf module 173 relative to at least one or more of the bot traverse reference level BTRL and the reference frame REFZ. The shelf supports 330 extend from opposite sides of the stanchion 310 in a direction (e.g., along the X direction in the storage and retrieval system 100 reference frame REFZ—see FIG. 1B) substantially orthogonal to the bot rail supports 320. The shelf supports 330 are arranged in pairs (e.g., an upper support 330U and lower support 330L) on the same (or a common) side of the stanchion 310 so as to engage a respective shelf module 173 at two locations for effecting the deterministic location of the shelf module 173. Each of the upper and lower support 330U, 330L includes a cantilevered base 330CB, a tapered stanchion 330TS (may also be conical, pyramidal, etc. for position/location setting as described herein), and an aperture 330A extending cross-wise through the stanchion 330TS.

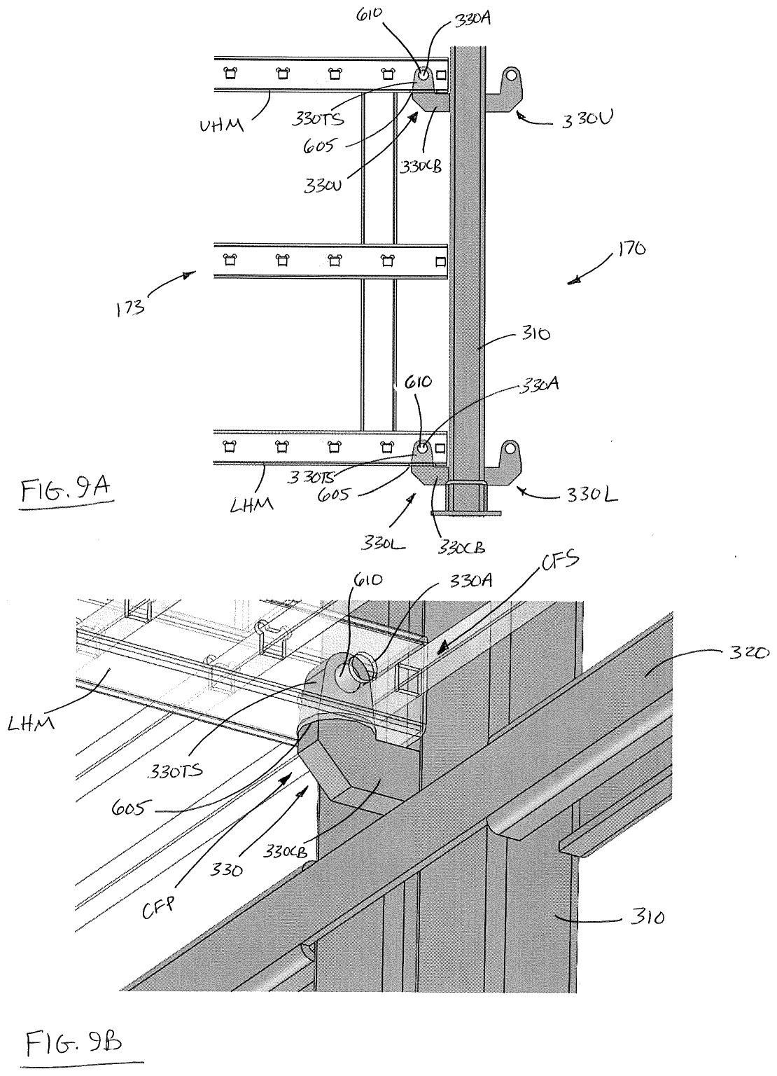

The tapered stanchion 330TS and aperture 330A, as illustrated in FIGS. 9A and 9B, engage a respective one of the uppermost horizontal member UHM and lowermost horizontal member LHM finally and repeatably positioning at least a height of the shelf module 173 relative to at least one or more of the bot traverse reference level BTRL and reference frame REFZ. As described herein, each of the uppermost horizontal member UHM and lowermost horizontal member LHM include the apertures 605, 610. Here the tapered stanchions 330TS of the upper support 330U and lower support 330L are inserted into (e.g., through relative movement between the post module 170 and the shelf module 173) so as to the engage a respective aperture 605 for locating the shelf module 173 in at least the X and Y directions (see reference frame REFZ) and, in some aspects, also the Z direction (e.g., relative to one or more of the bot traverse reference level BTRL and the reference frame REFZ). A dowel, pin, or other fastener is inserted through the aperture 610 of at least one of the uppermost horizontal member UHM and lowermost horizontal member LHM include the apertures 605, 610 so as to pass through the aperture 330A of the respective upper support 330U and lower support 330L so as to fix the Z position of the shelf module 173 (e.g., relative to one or more of the bot traverse reference level BTRL and the reference frame REFZ). The coupling between the upper support 330U and lower support 330L and the respective uppermost horizontal member UHM and lowermost horizontal member LHM is such that the coupling is not over constrained.

Referring to FIGS. 3A, 5, and 8, the post module 170 is configured to couple with the beam module 171 so as to finally and repeatably position and align the beam module 171 relative to at least one or more of the bot traverse reference level BTRL and the reference frame REFZ. Here, the post module 170 includes apertures 861, 862 (e.g., control features) disposed at an end (what may be referred to as a top end) of the post module 170 that is opposite the base 300. The apertures 861, 862 are arranged so as to align with the control features CFB (e.g., the slots and holes) of the beam module 171 so that alignment of the control features CFB with the apertures 861, 862 (as described herein-such that dowels, pins, etc. are inserted through the slots and holes of the beam module 171 so as to pass through the respective aperture 861, 862) finally and repeatably positions and aligns the beam module as noted above. Here, the apertures 861, 862 may be formed in the stanchion 310 of the post module 170 such as by employing the jig 1100 (see FIG. 11) or in any other suitable manner.

Referring to FIGS. 2A and 3A, each post module 170 is configured or otherwise formed (such as with jig 1100—see FIG. 11) with any suitable number of bot rail supports 320 so as to form any suitable number of respective storage levels 130L. For example, in one aspect a post module 170 may include three bot rail supports so as to form three respective storage levels 130L; while in other aspects a post module may include four bot rail supports so as to form four respective storage levels 130L. It is noted that the post modules 170 may be stacked one on the other so as to form the multilevel array RMA; while in other aspects, the post modules may be formed (such as with jig 1100—see FIG. 11) as a unitary member that spans from a bottom of the array 130SHA to a top of the array 130SHA (stacking of post modules is not required).

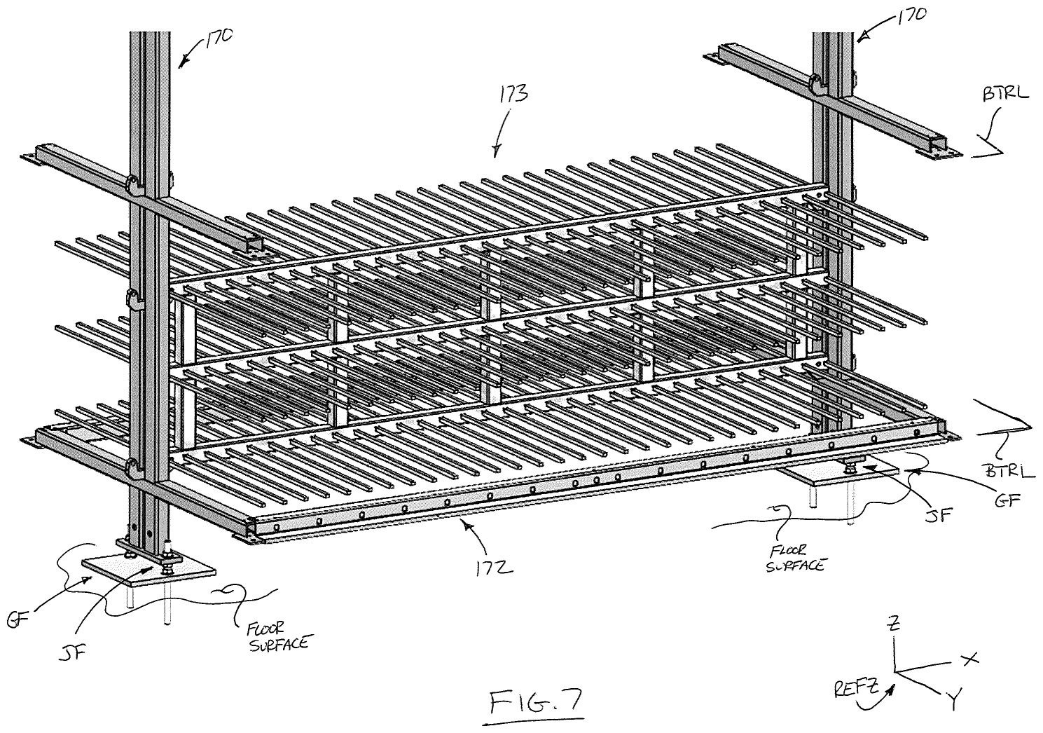

As described above, coupling of the modules 171-173 to the post module 170 automatically finally and repeatably positions and aligns each of the modules 171-173 to at least the bot traverse reference level BTRL. It is noted that the post modules 170 (e.g., prior assembly of one or more of the modules 171-173 to the post modules 170) may be adjusted along the Z axis (see reference frame REFZ) in any suitable manner so that the respective bot traverse reference frames BTRL are disposed at a predetermined position relative to any suitable reference frame REFZ of the storage and retrieval system 100 (or any other suitable reference frame, such as of a transfer deck, lift, etc.). For example, referring to FIGS. 2C and 7, each post module 170 includes any suitable jacking features JF (e.g., bolts, nuts, etc.) that are configured to raise and lower the post module 170 in the Z direction. As described herein, each post module 170 includes datum feature DFP, which upon installation of the post module 170 may be set at a predetermined height in the Z direction by employing any suitable measurement tools (e.g., lasers, calipers, rulers, etc.) so that upon coupling of the modules 171-173 to the post module 170, the position of the modules 171-173 is finally and repeatably positioned and aligned relative to the bot traverse reference level BTRL, which in turn is at a known predetermined position in the reference frame REFZ of the storage and retrieval system 100.

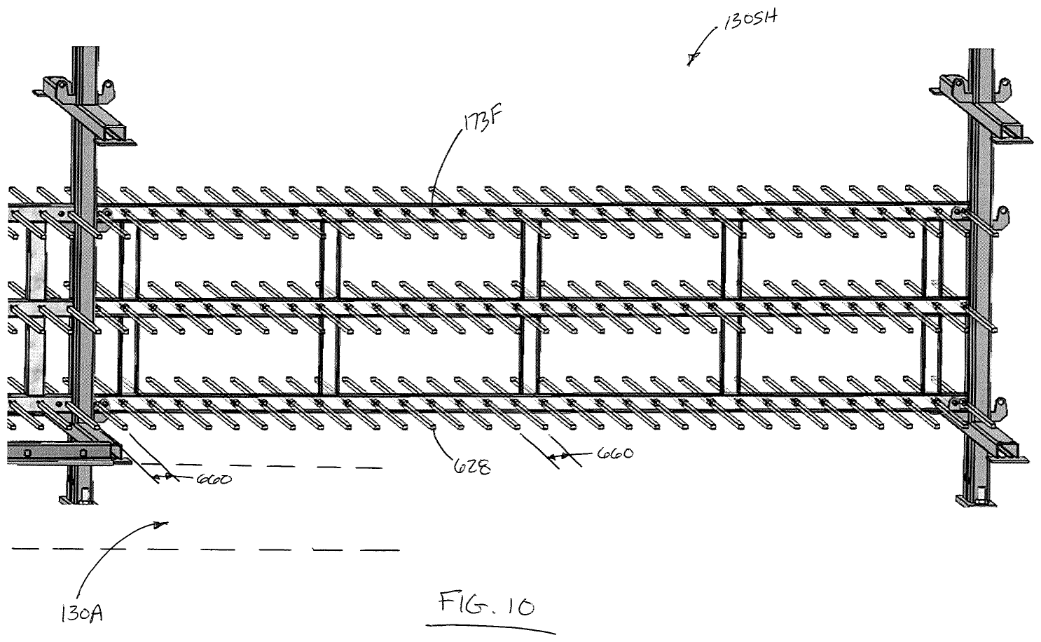

As noted herein, the modules 170-173 are configured to increase storage density of the storage structure 130 by providing substantially continuous or uninterrupted storage shelves along each picking aisle 130A of the shelving structure 130SH. For example, referring to FIG. 10, the post modules are dimensioned so that the post modules fit within the predetermined spacing 660 between shelf tines 628. As can also be seen in at least FIG. 10, shelf tines 628 are cantilevered from the spine or frame 173F, noting that the beam modules 171 are disposed above (and/or below) the frames 173F of the shelf module 173 (e.g., in a common plane of a stack of shelf modules 173). As such, the shelving support structure does not occupy space that would otherwise be employed for holding goods (e.g., warehouse packs or case units CU) arranged along the same (i.e., common) storage shelf. In other words, goods may be placed on a storage shelf 630 in dynamically allocated storage spaces disposed, uninterrupted, along the length of the picking aisle 130A.

Referring to FIG. 11, as noted herein each of the modules 171-173 may be formed separately from each other, simultaneously with each other, or in any other temporal manner with one or more assembly jig 1100 so that the control features CFR, CFS, CFB, CFP and integral structural datum feature DFP provide final and repeatable positioning and alignment of the modules, relative to each other and the bot traverse reference level BTRL, on installing the modules 171-173 in the assembly 130SHA in the array RMA. For example, each module 170-173 may have a reference datum. For example, for each modules 171-173, the jig is configured to position the structural members of the respective modules (e.g., frame members, posts, tines, etc.) relative to each other so a respective reference datum RDM (which may be one of the control features CFR, CFS, CFB) may be formed (e.g., cut, machined, etc.) in the structure of the module 171-173 where, the other control features are spatially located and formed in the module structure relative to the reference datum RDM. For the post module 170, the jig 1100 may be configured to position and align the structural components of the post module (e.g., frame members, beams, etc.) and spatially locate reference datum DFP and the control features CFP relative to the respective datums so that the reference datum DFP and control features CFP are formed in (e.g., cut, machined, etc.) into the post module structure. The control features CFP may be spatially located, by the jig 1100, relative to the reference datum DFP where the reference datum DFP also defines the location of the bot traverse reference level BTRL of the assembly 130SHA. The jig 1100 may also be configured to spatially position the reference datums RDM (and control features) of the modules 171-173 relative to the reference datum DFP of the post module 170 so that the modules 171-173 may be finally and repeatably positioned relative the post module 170 on installation of the modules 171-173 to the post module 170 as described herein.

The jig 1100 may have one or more base datum BD surfaces providing the basis for the reference datums of the modules 170-173 (e.g., one or more bot traverse reference level BTRL). The base datum BD surfaces (or features) may be determined from a desired global reference frame or datum (e.g., such as an origin of the reference frame REFZ of the storage and retrieval system 100 or any other suitable location within the storage and retrieval system 100). The jig 1100 may also have registration datum features, such as datum surfaces, laser position registration system, or optical position registration system, at a fixed predetermined position and attitude relative to the base datum BD surfaces of the jig 1100. The registration datum features may be employed to set the control features CFS, CFR, CFB, CFP (and datum DFP) of the modules 170-173 relative to each other. For example, to set the control features and datum relative to each other, the modules 170-173 (or their components) may be placed in the jig 1100 at predetermined locations relative to the basis datum BD of the jig. The control features CFS, CFR, CFB, CFP (and datum DFP) may be formed in the respective module 170-173 (located from the basis datum BD) using the registration datum features to effect interchangeability of modules 170-173 as described herein and the automatic alignment of the modules relative to each other and bot traverse reference level BTRL as described herein.

Referring to FIGS. 12A-12C the shelving structure 130SH may be configured to provide human (or humanoid) access to the picking aisles 130A. For example, the shelving structure 130SH includes a floor module 1200 that may be coupled to opposing rail module 172 of a picking aisle 130A (or other suitable structure of the shelving structure 130SH) so that on assembly of the floor module 1200 to the array RMA the floor module 1200 spans between the rail modules 172 of adjacent assemblies 130SHA. The floor module 1200 may be a wire mesh floor, a solid floor, or have any other suitable configuration so as to support a human. The floor module 1200 may be coupled to the rail modules 172 of the respective picking aisle 130A in any suitable manner, such as with mechanical fasteners (e.g., such as clips, straps, bolts, etc.).

Floor modules 1200 may be vertically spaced or stacked along the Z axis (see reference frame REFZ) at any suitable interval so that the human may access more than one level 130L from a common floor module 1200. FIG. 12 illustrates access to three storage levels 130L from a common floor module 1200 but in other aspects access to more or fewer than three storage levels 130L may be provided. In some aspects, a ladder 1220 may be provided in the picking aisle 130A to provide a human access to each shelf 630 of each storage level 130L belonging to the common floor module 1200. The ladder 1220 may include rollers/wheels that engage the rail modules 172 so that the ladder is stably held in a vertically inclined or vertical orientation and is slidable along a length of the picking aisle 130A to provide access to the stacked shelves 630 of a respective storage level 130L.

As may be realized, human access to the picking aisles 130A includes lock-out features that prevent self-navigating automatic robots 110 from entering the picking aisles occupied by the human. For example, maintenance access zones may be established in a manner substantially similar to that described in U.S. Pat. No. 11,629,015 issued on Apr. 18, 2023 (having U.S. Ser. No. 17/229,596 filed on Apr. 13, 2021), the disclosure of which is incorporated herein by reference in its entirety.

As may be realized, the modularity of the shelving structure 130SH described herein provides for expansion of the shelving structure 130SH in length (e.g., increase the length of the picking aisles 130) and/or in width (e.g., increase the number of picking aisles accessible from a transfer deck 130DC) so as to increase (or decrease) the storage capacity of the storage and retrieval system 100. Expansion of the length and/or width of the storage structure may be limited only by a size of the facility in which the storage structure is disposed.

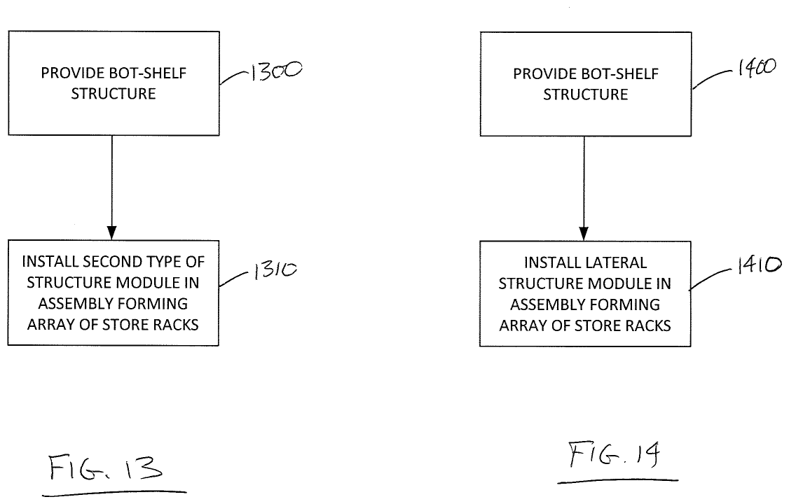

Referring to FIGS. 1A-10, 12A-12D, and 13 an exemplary method will be described in accordance with aspects of the present disclosure. In the method, the bot-shelf structure 130SH (as described herein), for the automatic store and retrieval system 100, is provided (FIG. 13, Block 1300). For example, the bot-shelf structure 130SH includes an array RMA of the store racks RM and bot traverse aisles 130A juxtaposed with the store racks RM. The bot traverse aisles 130A providing the self-navigating automatic robots 110 with access to the store racks RM, where the store racks RM and bot traverse aisles 130A of the array RMA are integrated into an assembly 130SHA with one or more elevated levels 130L, each level 130L having a predetermined bot traverse reference level BTRL. As described herein the assembly 130SHA includes a first type of structure module (e.g., such as post module 170) and a second type of structural module (e.g., at least one of modules 171-173). The first type of structural module defines a module part of the array, the assembly 130SHA having more than one of the first type of structure module, each of which is interchangeable with each other, and has an integral structural datum feature DFP determining the predetermined bot traverse reference level BTRL of each level 130L of the array RMA so that each placement, in the assembly, of the first type of structure module repeatably determines the predetermined bot traverse reference level BTRL throughout the array RMA at each level 130L. The second type of structure module is connected to the first type of structure module, where the second type of structure module is of a different type than the first type of structure module and defines a different module part of the array RMA.

The method also includes installing the second type of structure module in the assembly 130SHA forming the array RMA (FIG. 13, Block 1310), where the second type of structure module has control features CFS, CFB, CFR having a predetermined relationship with the integral structural datum feature DFP of the first type of structure module. The control features CFS, CFB, CFR being configured so that each second type of structure module is interchangeable with each other second type of structure module and defines position determining features that finally and repeatably position and align the second type of structure module, relative to the predetermined bot traverse reference level BTRL, on installing the second type of structure module in the assembly 130SHA forming the array RMA.

The method may also include one individually or more (in any suitable combination) of the following: the final and repeatable position and alignment is effected, with the control features CFS, CFB, CFR, substantially automatically on installation of the second type of structure module in the assembly 130SHA; joining the second type of structure module to the first type of structure module, where the second type of structure module depends from the first type of structure module; the final and repeatable position and alignment is effected, with the control features CFS, CFB, CFR, substantially coincident with installation of the second type of structure module in the assembly 130SHA; each second type of structure module at each level 130L of the array RMA is substantially automatically aligned with each other second type of structure module along the level 130L of the array RMA; the first type of structure module is based on a ground foundation GF and is substantially upright so that the integral structural datum feature DFP sets the predetermined bot traverse reference level BTRL of each array level 130L; the first type of structure module is at least a frame upright, post, or pillar (see post module 170) that frames and positions each second type of structure module; the second type of structure module is at least one of a rack shelf assembly 173 and bot rail 172; the bot rail 172 and rack shelf assembly 173 are decoupled from each other within the assembly 130SHA, and independently joined deterministically with respective position determining features (see FIGS. 4A-4C And 9A-9B) to the first type of structure module so that pose of the bot rail 172 and rack shelf assembly 173, relative to each other and to the bot traverse reference level BTRL, is repeatably determined for each installation of the bot rail 172 and rack shelf assembly 173; the control features CFS, CFB, CFR of the second type of structure module define a deterministic coupling and the first type of structure module has conformal mating features CFP (see FIGS. 3A-3C, 4A-4C, 8, and 9A-9C) that conform to and mate with the control features CFS, CFB, CFR of the second type of structure module and effect on mating repeatable deterministic and final positioning of the first type of structure modules and the second type of structure modules to each other, and within the assembly 130SHA, on mating; the second type of structure module is at least a rack shelf assembly 173, the rack shelf assembly 173 has a box frame 173F with box frame members that are separate and distinct from the first type of structure module, where the box frame 173F defines supports for more than one rack shelves 630, each rack shelf 630 being cantilevered from the box frame 173F; and the box frame 173F has control features CFS finally and repeatably positioning each rack shelf 630 relative to the bot traverse reference level BTRL on installing the rack shelf assembly 173 in the array 130SHA.

Referring to FIGS. 1A-10, 12A-12D, and 14 an exemplary method will be described in accordance with aspects of the present disclosure. In the method, the bot-shelf structure assembly 130SHA (as described herein) is provided (FIG. 14, Block 1400). For example, the bot-shelf structure assembly 130SH includes an array RMA of the store racks RM and bot traverse aisles 130A juxtaposed with the store racks RM. The bot traverse aisles 130A providing self-navigating automatic robots 110 access to the store racks RM, where the store racks RM and traverse aisles 130A of the assembly 130SHA have one or more elevated levels 130L, each level 130L having a predetermined bot traverse reference level BTRL. The assembly 130SHA includes a frame upright structure module 170 and a lateral structure module (e.g., at least one of 171-173). The frame upright structure module 170 defines a module part of the array RMA, the bot-shelf structure assembly 130SHA having more than one of the frame upright structure module 170, each of which is interchangeable with each other, and has an integral structural datum feature DFP determining the predetermined bot traverse reference level BTRL of each level 130L of the array RMA so that each placement, in the bot-shelf structure assembly 130SHA, of the frame upright structure module 170 repeatably determines the predetermined bot traverse reference level BTRL throughout the array RMA at each level 130L. The lateral structure module 171-173 is connected to the frame upright structure module 170. The lateral structure module 171-173 is different than the frame upright structure module 170 and defines a different module part of the array RMA.

The method also includes installing the lateral structure module 171-173 in the bot-shelf structure assembly 130SHA (FIG. 14, Block 1410). The lateral structure module 171-173 has control features CFS, CFB, CFR having a predetermined relationship with the integral structural datum feature DFP of the frame upright structure module 170, the control features CFS, CFB, CFR being configured so that each lateral structure module 171-173 is interchangeable with each other lateral structure module 171-173 (as described herein) and define position determining features that finally and repeatably position and align the lateral structure module 171-173, relative to the predetermined bot traverse reference level BTRL, on installing the lateral structure module 171-173 in the bot-shelf structure assembly 130SHA.

The method may also include one individually or more (in any suitable combination) of the following: the final and repeatable position and alignment is effected, with the control features CFS, CFB, CFR, substantially automatically on installation of the lateral structure module 171-173 in the bot-shelf structure assembly 130SHA; joining the lateral structure module 171-173 to the frame upright structure module 170, where the lateral structure module 171-173 depends from the frame upright structure module 170; the final and repeatable position and alignment is effected, with the control features CFS, CFB, CFR, substantially coincident with installation of the lateral structure module 171-173 in the bot-shelf structure assembly 130SHA; each lateral structure module 171-173 at each level 130L of the array RMA is substantially automatically aligned with each other lateral structure module 171-173 along the level 130L of the array RMA; the frame upright structure module 170 is based on a ground foundation GF and is substantially upright so that the integral structural datum feature DFP sets the predetermined bot traverse reference level BTRL of each array level 130L; the frame upright structure module 170 is at least a frame upright, post, or pillar that frames and positions each lateral structure module 171-173; the lateral structure module 171-173 is at least one of a rack shelf assembly 173 and bot rail 172; the bot rail 172 and rack shelf assembly 173 are decoupled from each other within the bot-shelf structure assembly 130SHA, and independently joined deterministically with respective position determining features to the frame upright structure module 170 so that pose of the bot rail 172 and rack shelf assembly 173, relative to each other and to the bot traverse reference level BTRL, is repeatably determined for each installation of the bot rail 172 and rack shelf assembly 173; the control features CFS, CFB, CFR of the lateral structure module 171-173 define a deterministic coupling and the frame upright structure module 170 has conformal mating features CFP (see FIGS. 3A-3C, 4A-4C, 8, and 9A-9C) that conform to and mate with the control features CFS, CFB, CFR of the lateral structure module 171-173 and effect on mating repeatable deterministic and final positioning of the frame upright structure modules 170 and the lateral structure modules 171-173 to each other, and within the bot-shelf structure assembly 130SHA, on mating; the lateral structure module 171-173 is at least a rack shelf assembly 173, the rack shelf assembly 173 has a box frame 173F with box frame members that are separate and distinct from the frame upright structure module 170, where the box frame 173F defines supports for more than one rack shelves 630, each rack shelf 630 being cantilevered from the box frame 173F; the box frame 173F has control features CFS finally and repeatably positioning each rack shelf 630 relative to the bot traverse reference level BTRL on installing the rack shelf assembly 173 in the array RMA.

The following aspects of the present disclosure are provided and may be employed individually, in any combination with each other, and/or in any combination with the features described above.

In accordance with aspects of the present disclosure, a bot-shelf structure, for an automatic store and retrieval system having store racks and self-navigating automatic robots, is provided. The bot-shelf structure includes: an array of the store racks and bot traverse aisles juxtaposed with the store racks, the bot traverse aisles providing the self-navigating automatic robots with access to the store racks, wherein the store racks and bot traverse aisles of the array are integrated into an assembly with one or more elevated levels, each level having a predetermined bot traverse reference level, and the assembly comprises: a first type of structure module that defines a module part of the array, the assembly having more than one of the first type of structure module, each of which is interchangeable with each other, and has an integral structural datum feature determining the predetermined bot traverse reference level of each level of the array so that each placement, in the assembly, of the first type of structure module repeatably determines the predetermined bot traverse reference level throughout the array at each level; and a second type of structure module connected to the first type of structure module, the second type of structure module being of a different type than the first type of structure module and defines a different module part of the array; and wherein the second type of structure module has control features having a predetermined relationship with the integral structural datum feature of the first type of structure module, the control features being configured so that each second type of structure module is interchangeable with each other second type of structure module and defines position determining features that finally and repeatably position and align the second type of structure module, relative to the predetermined bot traverse reference level, on installing the second type of structure module in the assembly forming the array.

In accordance with aspects of the present disclosure, the control features are configured so that final and repeatable position and alignment is effected substantially automatically on installation of the second type of structure module in the assembly.

In accordance with aspects of the present disclosure, the second type of structure module is joined to the first type of structure module, and the second type of structure module depends from the first type of structure module.

In accordance with aspects of the present disclosure, the control features are configured so that final and repeatable position and alignment is effected substantially coincident with installation of the second type of structure module in the assembly.

In accordance with aspects of the present disclosure, each second type of structure module at each level of the array is substantially automatically aligned with each other second type of structure module along the level of the array.

In accordance with aspects of the present disclosure, the first type of structure module is based on a ground foundation and is substantially upright so that the integral structural datum feature sets the predetermined bot traverse reference level of each array level.

In accordance with aspects of the present disclosure, the first type of structure module is at least a frame upright, post, or pillar that frames and positions each second type of structure module.

In accordance with aspects of the present disclosure, the second type of structure module is at least one of a rack shelf assembly and bot rail.

In accordance with aspects of the present disclosure, the bot rail and rack shelf assembly are decoupled from each other within the assembly, and independently joined deterministically with respective position determining features to the first type of structure module so that pose of the bot rail and rack shelf assembly, relative to each other and to the bot traverse reference level, is repeatably determined for each installation of the bot rail and rack shelf assembly.

In accordance with aspects of the present disclosure, the control features of the second type of structure module define a deterministic coupling and the first type of structure module has conformal mating features that conform to and mate with the control features of the second type of structure module and effect on mating repeatable deterministic and final positioning of the first type of structure modules and the second type of structure modules to each other, and within the assembly, on mating.

In accordance with aspects of the present disclosure, the second type of structure module is at least a rack shelf assembly, the rack shelf assembly has a box frame with box frame members that are separate and distinct from the first type of structure module, and wherein the box frame defines supports for more than one rack shelves, each rack shelf being cantilevered from the box frame.

In accordance with aspects of the present disclosure, the box frame has control features finally and repeatably positioning each rack shelf relative to the bot traverse reference level on installing the rack shelf assembly in the array.

In accordance with aspects of the present disclosure, an automatic store and retrieval system includes: a bot-shelf structure assembly with an array of the store racks and bot traverse aisles juxtaposed with the store racks, the bot traverse aisles providing self-navigating automatic robots access to the store racks, wherein the store racks and traverse aisles of the assembly have one or more elevated levels, each level having a predetermined bot traverse reference level, and the assembly includes: a frame upright structure module that defines a module part of the array, the assembly having more than one of the frame upright structure module, each of which being interchangeable with each other, and has an integral structural datum feature determining the predetermined bot traverse reference level of each level of the array so that each placement, in the assembly, of the frame upright structure module repeatably determines the predetermined bot traverse reference level throughout the array at each level; and a lateral structure module connected to the frame upright structure module, the lateral structure module being different than the frame upright structure module and defines a different module part of the array; and wherein the lateral structure module has control features having a predetermined relationship with the integral structural datum feature of the frame upright structure module, the control features being configured so that each lateral structure module is interchangeable with each other lateral structure module and define position determining features that finally and repeatably position and align the lateral structure module, relative to the predetermined bot traverse reference level, on installing the lateral structure module in the assembly.

In accordance with aspects of the present disclosure, the control features are configured so that final and repeatable position and alignment is effected substantially automatically on installation of the lateral structure module in the assembly.

In accordance with aspects of the present disclosure, the lateral structure module is joined to the frame upright structure module, and the lateral structure module depends from the frame upright structure module.

In accordance with aspects of the present disclosure, the control features are configured so that final and repeatable position and alignment is effected substantially coincident with installation of the lateral structure module in the assembly.

In accordance with aspects of the present disclosure, each lateral structure module at each level of the array is substantially automatically aligned with each other lateral structure module along the level of the array.

In accordance with aspects of the present disclosure, the frame upright structure module is based on a ground foundation and is substantially upright so that the integral structural datum feature sets the predetermined bot traverse reference level of each array level.

In accordance with aspects of the present disclosure, the frame upright structure module is at least a frame upright, post, or pillar that frames and positions each lateral structure module.

In accordance with aspects of the present disclosure, the lateral structure module is at least one of a rack shelf assembly and bot rail.

In accordance with aspects of the present disclosure, the bot rail and rack shelf assembly are decoupled from each other within the assembly, and independently joined deterministically with respective position determining features to the frame upright structure module so that pose of the bot rail and rack shelf assembly, relative to each other and to the bot traverse reference level, is repeatably determined for each installation of the bot rail and rack shelf assembly.

In accordance with aspects of the present disclosure, the control features of the lateral structure module define a deterministic coupling and the frame upright structure module has conformal mating features that conform to and mate with the control features of the lateral structure module and effect on mating repeatable deterministic and final positioning of the frame upright structure modules and the lateral structure modules to each other, and within the assembly, on mating.

In accordance with aspects of the present disclosure, the lateral structure module is at least a rack shelf assembly, the rack shelf assembly has a box frame with box frame members that are separate and distinct from the frame upright structure module, and wherein the box frame defines supports for more than one rack shelves, each rack shelf being cantilevered from the box frame.

In accordance with aspects of the present disclosure, the box frame has control features finally and repeatably positioning each rack shelf relative to the bot traverse reference level on installing the rack shelf assembly in the array.

In accordance with aspects of the present disclosure, a method includes: providing a bot-shelf structure for an automatic store and retrieval system having store racks and self-navigating automatic robots, the bot-shelf structure comprising: an array of the store racks and bot traverse aisles juxtaposed with the store racks, the bot traverse aisles providing the self-navigating automatic robots with access to the store racks, wherein the store racks and bot traverse aisles of the array are integrated into an assembly with one or more elevated levels, each level having a predetermined bot traverse reference level, and the assembly comprises: a first type of structure module that defines a module part of the array, the assembly having more than one of the first type of structure module, each of which is interchangeable with each other, and has an integral structural datum feature determining the predetermined bot traverse reference level of each level of the array so that each placement, in the assembly, of the first type of structure module repeatably determines the predetermined bot traverse reference level throughout the array at each level; and a second type of structure module connected to the first type of structure module, the second type of structure module being of a different type than the first type of structure module and defines a different module part of the array; and installing the second type of structure module in the assembly forming the array, where the second type of structure module has control features having a predetermined relationship with the integral structural datum feature of the first type of structure module, the control features being configured so that each second type of structure module is interchangeable with each other second type of structure module and defines position determining features that finally and repeatably position and align the second type of structure module, relative to the predetermined bot traverse reference level, on installing the second type of structure module in the assembly forming the array.

In accordance with aspects of the present disclosure, the final and repeatable position and alignment is effected, with the control features, substantially automatically on installation of the second type of structure module in the assembly.

In accordance with aspects of the present disclosure, the method further includes joining the second type of structure module to the first type of structure module, where the second type of structure module depends from the first type of structure module.

In accordance with aspects of the present disclosure, the final and repeatable position and alignment is effected, with the control features, substantially coincident with installation of the second type of structure module in the assembly.

In accordance with aspects of the present disclosure, each second type of structure module at each level of the array is substantially automatically aligned with each other second type of structure module along the level of the array.

In accordance with aspects of the present disclosure, the first type of structure module is based on a ground foundation and is substantially upright so that the integral structural datum feature sets the predetermined bot traverse reference level of each array level.

In accordance with aspects of the present disclosure, the first type of structure module is at least a frame upright, post, or pillar that frames and positions each second type of structure module.

In accordance with aspects of the present disclosure, the second type of structure module is at least one of a rack shelf assembly and bot rail.

In accordance with aspects of the present disclosure, the bot rail and rack shelf assembly are decoupled from each other within the assembly, and independently joined deterministically with respective position determining features to the first type of structure module so that pose of the bot rail and rack shelf assembly, relative to each other and to the bot traverse reference level, is repeatably determined for each installation of the bot rail and rack shelf assembly.

In accordance with aspects of the present disclosure, the control features of the second type of structure module define a deterministic coupling and the first type of structure module has conformal mating features that conform to and mate with the control features of the second type of structure module and effect on mating repeatable deterministic and final positioning of the first type of structure modules and the second type of structure modules to each other, and within the assembly, on mating.

In accordance with aspects of the present disclosure, the second type of structure module is at least a rack shelf assembly, the rack shelf assembly has a box frame with box frame members that are separate and distinct from the first type of structure module, and wherein the box frame defines supports for more than one rack shelves, each rack shelf being cantilevered from the box frame.

In accordance with aspects of the present disclosure, the box frame has control features finally and repeatably positioning each rack shelf relative to the bot traverse reference level on installing the rack shelf assembly in the array.

In accordance with aspects of the present disclosure, a method, in an automatic store and retrieval system, includes: providing a bot-shelf structure assembly with an array of the store racks and bot traverse aisles juxtaposed with the store racks, the bot traverse aisles providing self-navigating automatic robots access to the store racks, wherein the store racks and traverse aisles of the assembly have one or more elevated levels, each level having a predetermined bot traverse reference level, and the assembly includes: a frame upright structure module that defines a module part of the array, the bot-shelf structure assembly having more than one of the frame upright structure module, each of which being interchangeable with each other, and has an integral structural datum feature determining the predetermined bot traverse reference level of each level of the array so that each placement, in the bot-shelf structure assembly, of the frame upright structure module repeatably determines the predetermined bot traverse reference level throughout the array at each level; and a lateral structure module connected to the frame upright structure module, the lateral structure module being different than the frame upright structure module and defines a different module part of the array; and installing the lateral structure module in the bot-shelf structure assembly, where the lateral structure module has control features having a predetermined relationship with the integral structural datum feature of the frame upright structure module, the control features being configured so that each lateral structure module is interchangeable with each other lateral structure module and define position determining features that finally and repeatably position and align the lateral structure module, relative to the predetermined bot traverse reference level, on installing the lateral structure module in the bot-shelf structure assembly.

In accordance with aspects of the present disclosure, the final and repeatable position and alignment is effected, with the control features, substantially automatically on installation of the lateral structure module in the bot-shelf structure assembly.

In accordance with aspects of the present disclosure, the method further includes joining the lateral structure module to the frame upright structure module, where the lateral structure module depends from the frame upright structure module.

In accordance with aspects of the present disclosure, the final and repeatable position and alignment is effected, with the control features, substantially coincident with installation of the lateral structure module in the bot-shelf structure assembly.

In accordance with aspects of the present disclosure, each lateral structure module at each level of the array is substantially automatically aligned with each other lateral structure module along the level of the array.

In accordance with aspects of the present disclosure, the frame upright structure module is based on a ground foundation and is substantially upright so that the integral structural datum feature sets the predetermined bot traverse reference level of each array level.

In accordance with aspects of the present disclosure, the frame upright structure module is at least a frame upright, post, or pillar that frames and positions each lateral structure module.

In accordance with aspects of the present disclosure, the lateral structure module is at least one of a rack shelf assembly and bot rail.

In accordance with aspects of the present disclosure, the bot rail and rack shelf assembly are decoupled from each other within the assembly, and independently joined deterministically with respective position determining features to the frame upright structure module so that pose of the bot rail and rack shelf assembly, relative to each other and to the bot traverse reference level, is repeatably determined for each installation of the bot rail and rack shelf assembly.

In accordance with aspects of the present disclosure, the control features of the lateral structure module define a deterministic coupling and the frame upright structure module has conformal mating features that conform to and mate with the control features of the lateral structure module and effect on mating repeatable deterministic and final positioning of the frame upright structure modules and the lateral structure modules to each other, and within the bot-shelf structure assembly, on mating.

In accordance with aspects of the present disclosure, the lateral structure module is at least a rack shelf assembly, the rack shelf assembly has a box frame with box frame members that are separate and distinct from the frame upright structure module, and wherein the box frame defines supports for more than one rack shelves, each rack shelf being cantilevered from the box frame.

In accordance with aspects of the present disclosure, the box frame has control features finally and repeatably positioning each rack shelf relative to the bot traverse reference level on installing the rack shelf assembly in the array.

It should be understood that the foregoing description is only illustrative of the aspects of the present disclosure. Various alternatives and modifications can be devised by those skilled in the art without departing from the aspects of the present disclosure. Accordingly, the aspects of the present disclosure are intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the aspects of the present disclosure.

What is claimed is:

1. A bot-shelf structure for an automatic store and retrieval system having store racks and self-navigating automatic robots, the bot-shelf structure comprising:
an array of the store racks and bot traverse aisles juxtaposed with the store racks, the bot traverse aisles providing the self-navigating automatic robots with access to the store racks, wherein the store racks and bot traverse aisles of the array are integrated into an assembly with one or more elevated levels, each level having a predetermined bot traverse reference level, and the assembly comprises:
a first type of structure module that defines a module part of the array, the assembly having more than one of the first type of structure module, each of which is interchangeable with each other, and has an integral structural datum feature determining the predetermined bot traverse reference level of each level of the array so that each placement, in the assembly, of the first type of structure module repeatably determines the predetermined bot traverse reference level throughout the array at each level; and
a second type of structure module connected to the first type of structure module, the second type of structure module being of a different type than the first type of structure module and defines a different module part of the array; and
wherein the second type of structure module has control features having a predetermined relationship with the integral structural datum feature of the first type of structure module, the control features being configured so that each second type of structure module is interchangeable with each other second type of structure module and defines position determining features that finally and repeatably position and align the second type of structure module, relative to the predetermined bot traverse reference level, on installing the second type of structure module in the assembly forming the array.

2. The bot-shelf structure of claim 1, wherein the control features are configured so that final and repeatable position and alignment is effected substantially automatically on installation of the second type of structure module in the assembly.

3. The bot-shelf structure of claim 1, wherein the second type of structure module is joined to the first type of structure module, and the second type of structure module depends from the first type of structure module.

4. The bot-shelf structure of claim 1, wherein the control features are configured so that final and repeatable position and alignment is effected substantially coincident with installation of the second type of structure module in the assembly.

5. The bot-shelf structure of claim 1, wherein each second type of structure module at each level of the array is substantially automatically aligned with each other second type of structure module along the level of the array.

6. The bot-shelf structure of claim 1, wherein the first type of structure module is based on a ground foundation and is substantially upright so that the integral structural datum feature sets the predetermined bot traverse reference level of each array level.

7. The bot-shelf structure of claim 1, wherein the first type of structure module is at least a frame upright, post, or pillar that frames and positions each second type of structure module.

8. The bot-shelf structure of claim 1, wherein the second type of structure module is at least one of a rack shelf assembly and bot rail.

9. The bot-shelf structure of claim 8, wherein the bot rail and rack shelf assembly are decoupled from each other within the assembly, and independently joined deterministically with respective position determining features to the first type of structure module so that pose of the bot rail and rack shelf assembly, relative to each other and to the bot traverse reference level, is repeatably determined for each installation of the bot rail and rack shelf assembly.

10. The bot-shelf structure of claim 1, wherein the control features of the second type of structure module define a deterministic coupling and the first type of structure module has conformal mating features that conform to and mate with the control features of the second type of structure module and effect on mating repeatable deterministic and final positioning of the first type of structure modules and the second type of structure modules to each other, and within the assembly, on mating.

11. The bot-shelf structure of claim 1, wherein the second type of structure module is at least a rack shelf assembly, the rack shelf assembly has a box frame with box frame members that are separate and distinct from the first type of structure module, and wherein the box frame defines supports for more than one rack shelves, each rack shelf being cantilevered from the box frame.

12. The bot-shelf structure of claim 11, wherein the box frame has control features finally and repeatably positioning each rack shelf relative to the bot traverse reference level on installing the rack shelf assembly in the array.

13. An automatic store and retrieval system comprising:
a bot-shelf structure assembly with an array of the store racks and bot traverse aisles juxtaposed with the store racks, the bot traverse aisles providing self-navigating automatic robots access to the store racks, wherein the store racks and traverse aisles of the assembly have one or more elevated levels, each level having a predetermined bot traverse reference level, and the assembly includes:
a frame upright structure module that defines a module part of the array, the assembly having more than one of the frame upright structure module, each of which being interchangeable with each other, and has an integral structural datum feature determining the predetermined bot traverse reference level of each level of the array so that each placement, in the assembly, of the frame upright structure module repeatably determines the predetermined bot traverse reference level throughout the array at each level; and
a lateral structure module connected to the frame upright structure module, the lateral structure module being different than the frame upright structure module and defines a different module part of the array; and
wherein the lateral structure module has control features having a predetermined relationship with the integral structural datum feature of the frame upright structure module, the control features being configured so that each lateral structure module is interchangeable with each other lateral structure module and define position determining features that finally and repeatably position and align the lateral structure module, relative to the predetermined bot traverse reference level, on installing the lateral structure module in the assembly.

14. The automatic store and retrieval system of claim 13, wherein the control features are configured so that final and repeatable position and alignment is effected substantially automatically on installation of the lateral structure module in the assembly.

15. The automatic store and retrieval system of claim 13, wherein the lateral structure module is joined to the frame upright structure module, and the lateral structure module depends from the frame upright structure module.

16. The automatic store and retrieval system of claim 13, wherein the control features are configured so that final and repeatable position and alignment is effected substantially coincident with installation of the lateral structure module in the assembly.

17. The automatic store and retrieval system of claim 13, wherein each lateral structure module at each level of the array is substantially automatically aligned with each other lateral structure module along the level of the array.

18. The automatic store and retrieval system of claim 13, wherein the frame upright structure module is based on a ground foundation and is substantially upright so that the integral structural datum feature sets the predetermined bot traverse reference level of each array level.

19. The automatic store and retrieval system of claim 13, wherein the frame upright structure module is at least a frame upright, post, or pillar that frames and positions each lateral structure module.

20. The automatic store and retrieval system of claim 13, wherein the lateral structure module is at least one of a rack shelf assembly and bot rail.
